(19) United States
(12) Patent Application Publication
(10) Pub. No.: US 2019/0372719 A1
(43) Pub. Date: Dec. 5, 2019

(54) DESIGN OF DOWNLINK CONTROL INFORMATION FOR WIDEBAND COVERAGE ENHANCEMENT

(71) Applicant: Intel IP Corporation, Santa Clara, CA (US)

(72) Inventors: Salvatore Talarico, Sunnyvale, CA (US); Huaning Niu, San Jose, CA (US); Wenting Chang, Beijing (CN); Qiaoyang Ye, Fremont, CA (US)

(73) Assignee: Intel IP Corporation, Santa Clara, CA (US)

(21) Appl. No.: 16/484,438

(22) PCT Filed: Mar. 7, 2018
(86) PCT No.: PCT/US18/21420

§ 371 Date: Aug. 7, 2019

Related U.S. Application Data
(60) Provisional application No. 62/468,219, filed on Mar. 7, 2017.
(60) Provisional application No. 62/546,870, filed on Aug. 17, 2017.
(60) Provisional application No. 62/547,683, filed on Aug. 18, 2017.

(51) Int. Cl. H04L 1/18; H04W 16/26; H04W 72/04; H04L 1/00

(52) U.S. Cl. CPC H04L 1/189; H04L 1/0003; H04W 72/042; H04W 16/26

(57) ABSTRACT

Described is an apparatus of a User Equipment (UE). The apparatus may comprise a first circuitry, a second circuitry, and a third circuitry. The first circuitry may be operable to process a Downlink Control Information (DCI) transmission carrying one or more indicators for supporting Wideband Coverage Enhancement (WCE). The second circuitry may be operable to establish one or more repetition parameters based upon the one or more indicators for supporting WCE. The third circuitry may be operable to generate an Uplink (UL) transmission in a WCE mode in accordance with the one or more repetition parameters.

### CLAIM OF PRIORITY

The present application claims priority under 35 U.S.C. § 119(e) to U.S. Provisional Patent Application Ser. No. 62/468,219 filed Mar. 7, 2017 and entitled “DESIGN OF DOWNLINK CONTROL INFORMATION (DCI) FORMAT FOR WIDEBAND COVERAGE ENHANCEMENTS (WCE) IN MULTEFIRE,” to U.S. Provisional Patent Application Ser. No. 62/546,870 filed Aug. 17, 2017 and entitled “DOWNLINK CONTROL INFORMATION DESIGN FOR PHYSICAL DOWNLINK SHARED CHANNEL SCHEDULING FOR WIDEBAND COVERAGE ENHANCEMENT,” and to U.S. Provisional Patent Application Ser. No. 62/547,683 filed Aug. 18, 2017 and entitled “DOWNLINK CONTROL INFORMATION FOR DESIGN FOR PHYSICAL DOWNLINK SHARED CHANNEL SCHEDULING FOR WIDEBAND COVERAGE ENHANCEMENT,” which are herein incorporated by reference in their entirety.

### BACKGROUND

A variety of wireless cellular communication systems have been implemented, including a 3rd Generation Partnership Project (3GPP) Universal Mobile Telecommunications Systems (UMTS) system, a 3GPP Long-Term Evolution (LTE) system, and a 3GPP LTE-Advanced (LTE-A) system. Next-generation wireless cellular communication systems based upon LTE and LTE-A systems are being developed, such as a Fifth Generation (5G) wireless system/5G mobile networks system.

Next-generation wireless cellular communication systems may provide support for higher bandwidths in part by supporting use of unlicensed spectrum

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a scenario of various levels of coverage enhancement, in accordance with some embodiments of the disclosure.

FIG. 2 illustrates a scenario of coverage enhancement for Uplink (UL) transmissions, in accordance with some embodiments of the disclosure.

FIG. 3 illustrates a scenario of coverage enhancement for Downlink (DL) transmissions, in accordance with some embodiments of the disclosure.

FIG. 4 illustrates an Evolved Node-B (eNB) and a User Equipment (UE), in accordance with some embodiments of the disclosure.

FIG. 5 illustrates hardware processing circuitries for a UE for Downlink Control Information (DCI) processing for Wideband Coverage Enhancement (WCE), in accordance with some embodiments of the disclosure.

FIG. 6 illustrates methods for a UE for DCI processing for WCE for UL transmissions, in accordance with some embodiments of the disclosure.

FIG. 7 illustrates methods for a UE for DCI processing for WCE for DL transmissions, in accordance with some embodiments of the disclosure.

FIG. 8 illustrates example components of a device, in accordance with some embodiments of the disclosure.

FIG. 9 illustrates example interfaces of baseband circuitry, in accordance with some embodiments of the disclosure.

### DETAILED DESCRIPTION

Various wireless cellular communication systems have been implemented or are being proposed, including a 3rd Generation Partnership Project (3GPP) Universal Mobile Telecommunications System (UMTS), a 3GPP Long-Term Evolution (LTE) system, a 3GPP LTE-Advanced (LTE-A) system, and a 5th Generation (5G) wireless system/5G mobile networks system.

Due to the popularity of mobile devices and smart devices, the widespread adoption of wireless broadband has resulted in significant growth in the volume of mobile data traffic and has radically impacted system requirements, sometimes in divergent ways. For example, while it may be important to lower complexity, elongate battery life, and support highly mobility and service continuity of devices, it may also be important to increase data rates and bandwidths and lower latencies to support modern applications.

To meet the needs of future wireless networks, various physical layer techniques have been introduced (e.g, Multiple Input Multiple Output (MIMO) techniques, enhanced Inter-Cell Interference Coordination (ICIC) designs, coordinated multi-point designs, and so on). An increasing interest has also arisen in operating cellular networks in unlicensed spectrum to ameliorate the scarcity of licensed spectrum in low frequency bands, with the aim to further improve data rates. One enhancement for LTE in 3GPP Release 13 has been to enable operation in unlicensed spectrum via Licensed-Assisted Access (LAA), which may expand a system bandwidth by utilizing a flexible carrier aggregation (CA) framework introduced by the LTE-Advanced system. Enhanced operation of LTE systems in unlicensed spectrum is also expected in future releases, as well as in 5G systems.

Potential LTE operations in unlicensed spectrum may include (but not be limited to) LTE system operation in the unlicensed spectrum via Dual Connectivity (DC) (e.g., DC-based LAA), as well as LTE-based technology operating solely in unlicensed spectrum without relying upon an “anchor” in licensed spectrum (such as in MulteFire™ technology by MulteFire Alliance of Fremont Calif., USA).

Standalone LTE operation in unlicensed spectrum may combine performance benefits of LTE technology with a relative simplicity of Wi-Fi®-like deployments. (Wi-Fi® is a registered trademark of the Wi-Fi Alliance of Austin, Tex., USA.) Standalone LTE operation may accordingly be an advantageous technology in meeting demands of ever-increasing wireless traffic.

However, since WLAN systems are widely deployed both by individuals and by operators for carrier-grade access service and data offloading, further attention must be taken in designing and deploying MulteFire™ systems. Among other issues, it may be advantageous to target reduced complexity and reduced power consumption to elongate the battery life of a User Equipment (UE), yet it may also be advantageous to accounting for difficulties related to co-existence with unscheduled transmissions in parallel in the course of focusing toward lower cost devices.

It may also be advantageous to target improved coverage performance. Wideband Coverage Enhancement (WCE) may be advantageous in a variety of scenarios (such as indoor remote metering or remote maintenance and control). WCE may be furthered or achieved by, for example, repetition of critical control information, and cross-subframe channel estimation and scheduling.

Since 3GPP Release 13, WCE may be supported for machine-to-machine communication. As a first example, scheduling for Physical Uplink Shared Channel (PUSCH) may be performed via Downlink Control Information (DCI) format 6-0A for small repetition levels or no repetition levels, or via DCI format 6-0B for large repetition levels. As a second example, scheduling for Physical Downlink Shared Channel (PDSCH) may be performed for enhanced Machine-Type Communications (eMTC) via DCI format 6-1A for small repetition levels or no repetition levels, or via DCI format 6-1B for large repetition levels. Furthermore, DCI format 6-2 may be utilized for scheduling PDSCH with paging records, or for direct indication of System Information (SI) update, Public Warning System (PWS), and so on.

For completeness, Tables 1A to 1E below pertain to various aspects of various DCI formats. Some fields in Tables 1A to 1E may refer to Tables in 3GPP TS 36.212 v14.1.1 (2017-01) (“[1]”), which is hereby incorporated by reference in its entirety.

Table 1A provides a summary of fields and information transported in DCI format 6-0A, DCI format 6-0B, DCI format 6-1A, DCI format 6-1B, and DCI format 6-2. DCI format 6-0A and/or DCI format 6-0B may be used for scheduling of PUSCH. DCI format 6-1A, DCI format 6-1B, and/or DCI format 6-2 may be used for unicast PDSCH scheduling, System Information Block (SIB) scheduling, and/or paging. For unicast PDSCH, time repetition and Transport Block Size (TBS) scaling may be performed in order to facilitate a Maximum Coupling Loss (MCL) system design target.

While these DCI formats may be used to support Bandwidth-reduced Low-complexity/Coverage Enhancement (BL/CE) UEs in eMTC, they might not be supported in MulteFire systems, for various reasons. For example, DCI formats may not be designed in 3GPP standards to be used in frame structure type 3. Moreover, the length of some of the fields (e.g., Hybrid Automatic Repeat Request (HARQ) identifier (ID) process and/or Resource Block (RB) assignment) may not be sufficiently long to include information advantageous to MulteFire™ WCE and/or to scale for higher system bandwidths.

Table 1A includes fields that may be carried when the corresponding DCIs are used for scheduling purposes. “U” may indicate a number of Uplink (UL) physical resource blocks over a whole system bandwidth, and “D” may indicate a number of Downlink (DL) physical resource blocks over a whole system bandwidth. “N” may indicate a virtual resources block (VRB) increment step.

TABLE 1A
DCI format 6-0A, DCI format 6-0B, DCI format 6-1A, DCI format 6-1B, and DCI format 6-2

| | DCI | DCI | DCI | DCI | DCI |
|---|---|---|---|---|---|
| | format | format | format | format | format |
| | 6-0A | 6-0B | 6-1A | 6-1B | 6-2 |
| Fields | (bits) | (bits) | (bits) | (bits) | (bits) |
| Format 0A-1A or | 1 | 1 | 1 | 1 | — |
| 0B-1B | | | | | |
| Frequency hopping | 1 | — | 1 | — | — |
| flag | | | | | |
| Resource block | Log2(U/6) + 5 | Log2(U/6) + 3 | Log2(D/6) + 5 | Log2(D/6) + 1 | Log2(N/6) |
| assignment | | | | | (if flag = 1) |
| MCS | 4 | 4 | 4 | 4 | 3 |
| | | | | | (if flag = 1) |
| Repetition number | 2 | 3 | 2 | 3 | 3 |
| | | | | | (if flag = 1) |
| HARQ ID | 3 | 1 | 3 | 1 | — |
| New Data Indicator | 1 | 1 | 1 | 1 | — |
| Redundancy version | 2 | — | 2 | — | — |
| TPC command | 2 | — | 2 | — | — |
| UL index | 2 | — | — | — | — |
| Downlink | 2 for TDD, | — | from Table | — | — |
| assignment index | 0 for FDD | | 5.3.3.1.2-2 | | |
| | | | in [1] | | |
| CSI request | 1 | — | | — | — |
| SRS request | 1 | — | 1 | — | — |
| DCI subframe | 2 | 2 | 2 | 2 | 2 |
| repetition number | | | | | (if flag = 1) |
| Antenna port and | — | — | 2 | — | — |
| scrambling identity | | | | | |
| TPMI information | — | — | from Table | — | — |
| for precoding | | | 5.3.3.1.3A-1 | | |
| | | | in [1] | | |
| HARQ-ACK | — | — | 2 | 2 | — |
| resource offset | | | | | |
| PMI confirmation | — | — | 1 | — | — |
| for precoding | | | | | |
| Direct Indication | — | — | — | — | 8 |
| Information | | | | | (if flag = 0) |
| Flag for | — | — | — | — | 1 |
| paging/direct | | | | | |
| indication | | | | | |

In legacy LTE, PDSCH scheduling may be performed through the use of DCIs according to Table 1B.

TABLE 1B
Purpose of various PCI formats

| DCI | |
|---|---|
| formats | Purpose |
| 1 | SISO PDSCH Scheduling |
| 1A | SISO compact PDSCH scheduling |
| 1B | MIMO compact PDSCH scheduling |
| 1C | SISO very compact PDSCH scheduling for MU-MIMO |
| 1D | Compact PDSCH scheduling with power offset |
| 2 | Closed-loop MIMO compact PDSCH scheduling |
| 2A | Open-loop MIMO compact PDSCH scheduling |
| 2B | PDSCH scheduling for transmission mode 8 (TM8) - dual layer |
| | beamforming |
| 2C | PDSCH scheduling for transmission mode 9 (TM9) |
| 2D | PDSCH scheduling for transmission mode 10 (TM10) |

DCI format 1x may be used for single-transport-block (TB) configurations. DCI format 1 may be used for Single Input Single Output (SISO) with random access (RA) type 0 and RA type 1. DCI format 1A, which may be compact in comparison with DCI format 1 in order to reduce a bit field for RA type 2, may also be utilized for Random Access channel (RACH) triggering, paging scheduling, SI transmission, as well as broadcasting like service, and may be scrambled by various Radio Network Temporary Identifier (RNTI), such as a System Information RNTI (SI-RNTI), a Paging RNTI (P-RNTI), and/or a Global System for Mobile Communications (GSM) Enhanced Data rates for GSM Evolution (EDGE) Radio Access Network (GERAN) RNTI (G-RNTI). DCI format 1B may be for used for single layer close loop MIMO with Precoding Matrix Indicator (PMI) indicated. DCI format 1C may be used for very compact PDSCH, which may be utilized for Common Search Space (CSS). DCI format 1D may be similar to DCI format 1B, but may have a 1-bit interpretation used for downlink power offset to support Multi-User MIMO (MU-MIMO).

DCI format 2x may be used for two-TB configurations. DCI format 2 may be used to configure two TBs, including Modulation Coding Scheme (MCS), New Data Indicator (NDI), Redundancy Version (RV), and/or Multi-User Superposition Transmission (MUST) interference presence, and related PMI. DCI format 2, DCI format 2A, DCI format 2B, DCI format DCI format 2C, and/or DCI format 2D may be used for different MIMO modes, with different PMI interpretations, which may be close-loop, open-loop, transmission mode (TM) 8 (TM8), TM 9 (TM9), and/or TM 10 (TM10), respectively.

The Cyclic Redundancy Check (CRC) of a DCI may be scrambled with a specific RNTI. For example, one of the following RNTI can be used. A Cell RNTI (C-RNTI) may be a unique identification used for identifying Radio Resource Control (RRC) connection and scheduling which may be dedicated to a particular UE. (The use of C-RNTI in legacy LTE systems is summarized, for example, in Table 1C.) An SI-RNTI may be used for broadcast of SI. DCI formats which carry scheduling information for SI in legacy LTE may be DCI format 1A and DCI format 1C in common search space. (The use of SI-RNTI in legacy LTE systems is summarized, for example, in Table 1C.) A P-RNTI may be used by UEs for reception of paging. DCI formats which carry scheduling information for paging in legacy LTE may be DCI format 1A and DCI format 1C in common search space. (The use of P-RNTI in legacy LTE is summarized, for example, in Table 1C.)

TABLE 1C
Utilization of C-RNTI/SI-RNTI/P-RNTI in legacy LTE systems

| | | Trans- | |
|---|---|---|---|
| RNTI | DCI | mission | Transmission scheme of PDSCH |
| type | format | mode | corresponding to PDCCH |
| SI-RNTI | 1A/1C | | If the number of PBCH antenna ports |
| | | | is one, single-antenna port, port 0 is |
| | | | used, otherwise transmit diversity |
| P-RNTI | 1A/1C | | If the number of PBCH antenna ports |
| | | | is one, single-antenna port, port 0 is |
| | | | used, otherwise transmit diversity |
| C-RNTI | 1/1A | Mode 1 | Single-antenna port, port 0 |
| C-RNTI | 1/1A | Mode 2 | Transmit diversity |
| C-RNTI | 1A/2A | Mode 3 | Transmit diversity or large delay CDD |
| C-RNTI | 1A/2 | Mode 4 | Closed-loop spatial multiplexing or |
| | | | transmit diversity |
| C-RNTI | 1A/1D | Mode 5 | Multi-user MIMO |
| C-RNTI | 1A/1B | Mode 6 | Closed-loop spatial multiplexing using |
| | | | a single transmission layer |
| C-RNTI | 1/1A | Mode 7 | If the number of PBCH antenna ports |
| | | | is one, single-antenna port, port 0 is |
| | | | used, otherwise transmit diversity |
| C-RNTI | 2B | Mode 8 | Dual layer beamforming |
| C-RNTI | 2C | Mode 9 | Up to 8 layer transmission |
| C-RNTI | 2D | Mode 10 | Coordinated Multi Point Transmission |
| | | | with Up to 8 layer transmission |

Table 1D provides a summary of various fields for DCI format 1, DCI format 1A, DCI format 1B, DCI format 1C, and DCI format 1D, when these DCIs are used for PDSCH and SIB scheduling, as well as for paging. In this Table, “V” may indicate a maximum number of DL VRBs, N may indicate a VRB increment step, and P may depend upon the resource blocks and may be given by Table 1E.

Table 1E shows the value of P, which may be a Resource Block Group (RGB) Size, according to the DL system BW. Table 1E may be substantially similar to Table 7.1.6.1-1 of 3GPP technical specification (TS) 36.213 v14.1.1 (2017-01), which is hereby incorporated by reference in its entirety. Additionally, some fields in Table 1D may refer to Tables in 3GPP TS 36.212 v14.1.1 (2017-01), which are hereby incorporated by reference in its entirety.

TABLE 1D
Fields for DCI format 1, DCI format 1a, DCI format 1b, DCI format 1c, and DCI format 1d

| | DCI | DCI | DCI | DCI | DCI |
|---|---|---|---|---|---|
| | format | format | format | format | format |
| | 1 | 1A | 1B | 1C | 1D |
| Fields | (bits) | (bits) | (bits) | (bits) | (bits) |
| Carrier indicator | 0 or 3 | 0 or 3 | 0 or 3 | — | 0 or 3 |
| Format 0/1A format | — | 1 | — | — | — |
| Localized/Distributed | — | 1 | 1 | — | 1 |
| VRB flag | | | | | |
| Resource Block | V/P | Log2(V | Log2(V | Log2(V/N | Log2(V/N |
| assignment | | (V + 1)/2) | (V + 1)/2) | (V/N + 1)/2) | (V/N + 1)/2) |
| Modulation and coding | 5 | 5 | 5 | 5 | 5 |
| scheme (MCS) | | | | | |
| HARQ process number | 3 | 4 | 3 | — | 3 |
| New data indicator | 1 | 1 | 1 | — | 1 |
| Redundancy version | 2 | 2 | 2 | — | 2 |
| TPC command for | 2 | 2 | 2 | — | 2 |
| PUCCH | | | | | |
| Downlink assignment | Table | Table | Table | — | Table |
| index | 5.3.3.1.2-2 | 5.3.3.1.2-2 | 5.3.3.1.2-2 | | 5.3.3.1.2-2 |
| | in [1] | in [1] | in [1] | | in [1] |
| SRS request | — | 0 or 1 | — | — | — |
| HARQ-ACK resource | 2 | 0 or 2 | 2 | — | 2 |
| offset | | | | | |
| HARQ-ACK resource | — | 2 | — | — | — |
| indicator | | | | | |
| SRS timing offset | — | 3 | — | — | — |
| Gap indication | — | — | — | 1 | — |
| Resource allocation | 1 | — | — | — | — |
| header | | | | | |
| Must Interference | 0 or 2 bits | — | — | — | — |
| presence and power ratio | | | | | |
| TPMI information for | — | — | 5.3.3.1.3A-1 | — | 5.3.3.1.4A-1 |
| precoding | | | in [1] | | in [1] |
| PMI confirmation for | — | — | 1 | — | — |
| precoding | | | | | |
| Downlink power offset | — | — | — | — | 1 |

TABLE 1E
RGB Size (P) according to DL system BW

| System Bandwidth | RBG Size |
|---|---|
| N_{RB}^{DL} | (P) |
| ≤10 | 1 |
| 11-26 | 2 |
| 27-63 | 3 |
| 64-110 | 4 |

Table 1F provides a summary of various fields for DCI format 2, DCI format 2A, DCI format 2B, DCI format 2C, and DCI format 2D, when these DCIs are used for PDSCH and SIB scheduling, as well as for paging. In Table 1F, V may indicate a maximum number of DL virtual resources blocks (VRB), N may indicate a VRB increment step, and P may depend upon the resource blocks as indicated in Table 1E.

TABLE 1F
fields of DCI format 2, DCI format 2A, DCI
format 2B, DCI format 2C, and DCI format 2D

| | DCI | DCI | DCI | DCI | DCI |
|---|---|---|---|---|---|
| | format | format | format | format | format |
| | 2 | 2A | 2B | 2C | 2D |
| Fields | (bits) | (bits) | (bits) | (bits) | (bits) |
| Carrier indicator | 0 or 3 | 0 or 3 | 0 or 3 | 0 or 3 | 0 or 3 |
| Resource Block | V/P | V/P | V/P | V/P | V/P |
| assignment | | | | | |
| Modulation and coding | 5 | 5 | 5 | 5 | 5 |
| scheme (MCS) | | | | | |
| HARQ process number | 3 | 3 | 3 | 3 | 3 |
| New data indicator | 1 | 1 | 1 | 1 | 1 |
| Redundancy version | 2 | 2 | 2 | 2 | 2 |
| TPC command for | 2 | 2 | 2 | 2 | 2 |
| PUCCH | | | | | |
| Downlink assignment | Table | Table | Table | Table | Table |
| index | 5.3.3.1.2-2 | 5.3.3.1.2-2 | 5.3.3.1.2-2 | 5.3.3.1.2-2 | 5.3.3.1.2-2 |
| | in [1] | in [1] | in [1] | in [1] | in [1] |
| SRS request | — | — | 0 or 1 | 0 or 1 | 0 or 1 |
| HARQ-ACK resource | 2 | 2 | 2 | 2 | 2 |
| offset | | | | | |
| SRS timing offset | — | — | 3 | 3 | — |
| Resource allocation | 1 | 1 | 1 | 1 | 1 |
| header | | | | | |
| Must Interference | 0 or 2 bits | — | 0 or 2 | 0 or 2 or | 0 or 2 or |
| presence and power | | | | 4 or 6 | 4 or 6 |
| ratio | | | | | |
| Precoding information | 5.3.3.1.5-3 | 5.3.3.1.5A-1 | — | — | — |
| | in [1] | in [1] | | | |
| Scrambling identity | — | — | 1 | — | — |
| Transport block to | 1 | 1 | — | — | — |
| codeword swap flag | | | | | |
| Antenna ports, | — | — | — | 3 | 3 |
| scrambling identity, | | | | | |
| and number of layers | | | | | |
| PDSCH RE Mapping | — | — | — | — | 2 |
| and Quasi-Co-Location | | | | | |
| indicator | | | | | |

Disclosed herein are methods and mechanisms for design of Physical Downlink Control Channel (PDCCH) for the scheduling, in a WCE mode, of one or more of PUSCH or PDSCH, which may be applicable in MulteFire systems. These methods and mechanisms may advantageously facilitate or enable appropriate scheduling of PDSCH (e.g., unicast PDSCH), PUSCH, SIB, and/or paging.

A first variety of embodiments may support scheduling for UL transmissions for WCE (e.g., in MulteFire™ systems), such as PUSCH transmissions. A first type of embodiment may pertain to reuse and/or extension of DCI format 0A and/or DCI format 4A. A second type of embodiment may pertain to reuse and/or extension of DCI format 6-0A and/or DCI format 6-0B. A third type of embodiment may pertain to a clean slate solution with a design of a new DCI format which carries various useful information.

A second variety of embodiments may support scheduling for DL transmissions for WCE (e.g., in MulteFire™ systems), such as PDSCH transmissions, SIB scheduling transmissions, and paging transmissions. A first type of embodiment may pertain to reuse and/or extension of DCI format 1A and/or DCI format 1C. A second type of embodiment may pertain to reuse and/or extension of DCI format 6-1A, DCI format 6-1B, and/or DCI format 6-2. A third type of embodiment may pertain to a clean slate solution with a design of a new DCI format which carries various useful information.

A third variety of embodiments may support scheduling for various transmissions for WCE (e.g., in MulteFire™ systems). A first type of embodiment may pertain to reuse and/or extension of DCI format 1A and/or DCI format 1C. A second type of embodiment may pertain to reinterpretation of fields of various DCI formats, and incorporation of information related to numbers of repetitions within some fields (e.g., some unused fields). A third type of embodiment may pertain to reuse and/or modification of DCI format 6-1A, DCI format 6-1B, and/or DCI format 6-2.

Moreover, various embodiments may pertain to one or more of the first variety of embodiments, the second variety of embodiments, and the third variety of embodiments (and/or to types of embodiments thereof).

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

In addition, for purposes of the present disclosure, the term “eNB” may refer to a legacy LTE capable Evolved Node-B (eNB), a next-generation or 5G capable eNB, an Access Point (AP), and/or another base station for a wireless communication system. The term “gNB” may refer to a 5G-capable or NR-capable eNB. For purposes of the present disclosure, the term “UE” may refer to a legacy LTE capable User Equipment (UE), a Station (STA), and/or another mobile equipment for a wireless communication system. The term “UE” may also refer to a next-generation or 5G capable UE.

Various embodiments of eNBs and/or UEs discussed below may process one or more transmissions of various types. Some processing of a transmission may comprise demodulating, decoding, detecting, parsing, and/or otherwise handling a transmission that has been received. In some embodiments, an eNB or UE processing a transmission may determine or recognize the transmission's type and/or a condition associated with the transmission. For some embodiments, an eNB or UE processing a transmission may act in accordance with the transmission's type, and/or may act conditionally based upon the transmission's type. An eNB or UE processing a transmission may also recognize one or more values or fields of data carried by the transmission. Processing a transmission may comprise moving the transmission through one or more layers of a protocol stack (which may be implemented in, e.g., hardware and/or software-configured elements), such as by moving a transmission that has been received by an eNB or a UE through one or more layers of a protocol stack.

Various embodiments of eNBs and/or UEs discussed below may also generate one or more transmissions of various types. Some generating of a transmission may comprise modulating, encoding, formatting, assembling, and/or otherwise handling a transmission that is to be transmitted. In some embodiments, an eNB or UE generating a transmission may establish the transmission's type and/or a condition associated with the transmission. For some embodiments, an eNB or UE generating a transmission may act in accordance with the transmission's type, and/or may act conditionally based upon the transmission's type. An eNB or UE generating a transmission may also determine one or more values or fields of data carried by the transmission. Generating a transmission may comprise moving the transmission through one or more layers of a protocol stack (which may be implemented in, e.g., hardware and/or software-configured elements), such as by moving a transmission to be sent by an eNB or a UE through one or more layers of a protocol stack.

In various embodiments, resources may span various RBs, Physical Resource Blocks (PRBs), and/or time periods (e.g., frames, subframes, and/or slots) of a wireless communication system. In some contexts, allocated resources (e.g., channels, Orthogonal Frequency-Division Multiplexing (OFDM) symbols, subcarrier frequencies, resource elements (REs), and/or portions thereof) may be formatted for (and prior to) transmission over a wireless communication link. In other contexts, allocated resources (e.g., channels, OFDM symbols, subcarrier frequencies, REs, and/or portions thereof) may be detected from (and subsequent to) reception over a wireless communication link.

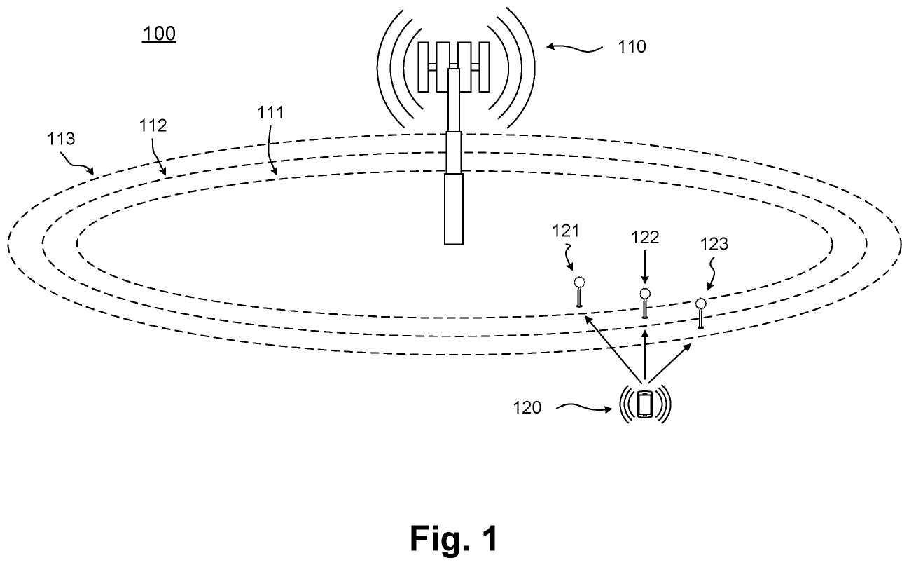

FIG. 1 illustrates a scenario of various levels of coverage enhancement, in accordance with some embodiments of the disclosure. A scenario 100 may comprise an eNB 110 and a UE 120. eNB 110 may serve a first cell area 111 at a first degree of coverage enhancement, may serve a second cell area 112 at a second degree of coverage enhancement, and may serve a third cell area 113 at a third degree of coverage enhancement.

UE 120 may be positioned at a first location 121 within first cell area 111, and may operate at the first degree of coverage enhancement. Alternatively, UE 120 may be positioned at a second location 122 within second cell area 112, and may operate at the second degree of coverage enhancement. As a further alternative, UE 120 may be positioned at a third location 123 within third cell area 113, and may operate at the third degree of coverage enhancement.

Various embodiments disclosed herein may pertain to WCE for UL transmissions, such as PUSCH transmissions. Various embodiments disclosed herein may also pertain to WCE for DL transmissions, such as PDSCH transmissions, or SIB scheduling transmissions, or paging transmissions. Various embodiments disclosed herein may pertain to scheduling for various transmissions for WCE, in general.

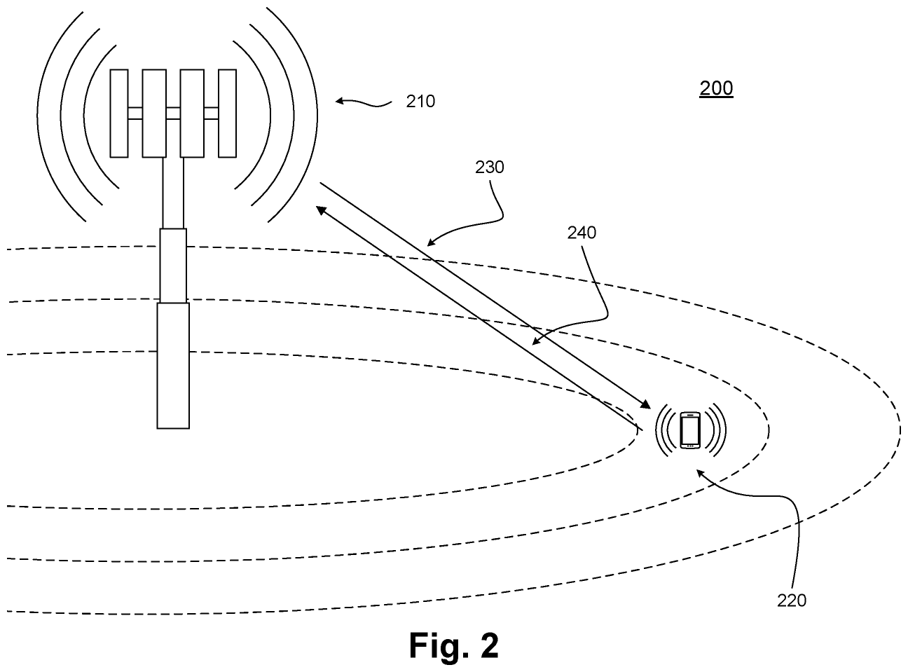

A first variety of embodiments may support scheduling for UL transmissions for WCE (e.g., in MulteFire™ systems), such as PUSCH transmissions. FIG. 2 illustrates a scenario of coverage enhancement for UL transmissions, in accordance with some embodiments of the disclosure. A scenario 200 may comprise an eNB 210 and a UE 220. eNB 210 may transmit a DCI transmission 230 to UE 220. DCI transmission 230 may carry one or more indicators for supporting WCE. UE 220 may establish one or more repetition parameters based upon the one or more indicators for supporting WCE (such as repetition parameters for WCE for UL transmissions). UE 220 may then transmit a UL transmission 240 in a WCE mode in accordance with the one or more repetition parameters (for example, by repeating UL transmission 240 in a time domain and/or a frequency domain in accordance with the one or more repetition parameters).

In a first type of embodiment for supporting scheduling for UL transmissions for WCE (e.g., PUSCH transmissions), DCI format 0A, DCI format 0B, DCI format 4A, and/or DCI format 4B may be used for scheduling PUSCH. (In some embodiments, those DCI formats may be used for enhanced Physical Uplink Control Channel (ePUCCH), such as a MulteFire™ ePUCCH (MF-ePUCCH) in a MulteFire™ cell). DCI format 0A and/or DCI format 0B may be used for scheduling of PUSCH for single subframes (or MF-ePUCCH for multiple subframes). Table 2 below provides a summary of fields carried by these DCI formats. In some embodiments, DCI format 4A and DCI format 4B may be used with a multi-antenna port transmission mode.

TABLE 2
DCI format 0A, DCI format 0B, DCI format 4A, DCI format 4B

| | DCI | DCI | DCI | DCI |
|---|---|---|---|---|
| | format | format | format | format |
| | 6-0A | 6-0B | 6-1A | 6-1B |
| Fields | (bits) | (bits) | (bits) | (bits) |
| Carrier indicator | 0 or 3 | 0 or 3 | 0 or 3 | 0 or 3 |
| Format 0A/1A | 1 | — | — | — |
| format | | | | |
| PUSCH or | 1 | 1 | 1 | 1 |
| MF-ePUCCH | | | | |
| trigger A | | | | |
| Timing offset | 4 | 4 | 4 | 4 |
| Resource block | 5 or 6 | 5 or 6 | 5 or 6 | 5 or 6 |
| assignment | | | | |
| Modulation and | 5 | 5 | 10 | 10 |
| coding scheme | | | | |
| HARQ ID | 4 | 4 | 4 | 4 |
| New Data | 1 | S | 2 | 2S |
| Indicator | | | | |
| Redundancy | 2 | S | 2 | S |
| version | | | | |
| TPC command | 2 | 2 | 2 | 2 |
| Cyclic shift for | 3 | 3 | 3 | 3 |
| DM-RS and OCC | | | | |
| index | | | | |
| CSI request | 1, 2, or 3 | 1, 2, or 3 | 1, 2, or 3 | 1, 2, or 3 |
| HARQ-ACK | 1 | 1 | 1 | 1 |
| request | | | | |
| SRS request | 1 | 2 | 2 | 2 |
| PUSCH or | 2 | 2 | 2 | 2 |
| MF-ePUCCH | | | | |
| starting position | | | | |
| PUSCH or | 1 | 1 | 1 | 1 |
| MF-ePUCCH | | | | |
| ending symbol | | | | |
| Channel access | 1 | 1 | 1 | 1 |
| type | | | | |
| Channel access | 2 | 2 | 2 | 2 |
| priority class | | | | |
| Number of | — | 1 or 2 | — | 1 or 2 |
| scheduled | | | | |
| subframes | | | | |

In some embodiments, for WCE, these DCI formats may be extended to include additional information related to WCE and used to allocate resources. For instance, one or more additional fields may be added.

Some embodiments may incorporate a repetition number field (which may be 2 bits or 3 bits, depending upon whether we adopt CE mode A or CE mode B, or may be 4 bits). The repetition number field may carry information related to a number of PUSCH repetition levels. The repetition number may be utilized to indicate a number of time domain repetitions, or a number of frequency domain repetitions, or both. The repetition number field may be separate indication or a joint indication.

For a separate indication, a first number of bits (e.g., the first two bits) may be used to indicate a number of time domain repetitions, and a second number of bits (e.g., the last two bits) may be used to indicate a number of frequency domain repetitions. An example of this is shown in Table 3 below. Alternatively, a number of time domain repetitions and a number of frequency domain repetitions may be carried using different field lengths (e.g., two bits for a number of frequency-domain repetitions, and one bit for a number of time-domain repetitions).

TABLE 3
An example number of repetition when two bits are used

| Indicator | Repetition times |
|---|---|
| first value | no repetition |
| (e.g., “00”) | |
| second value | 2 times |
| (e.g., “01”) | |
| third value | 4 times |
| (e.g., “10”) | |
| fourth value | 8 times |
| (e.g., “11”) | |

A maximum number of repetitions Nmax may be configured by eNB (e.g., through higher-layer signaling). A number-of-repetitions indicator may then be interpreted as specifying a fraction of the Nmax. An example of this is shown in Table 4 below.

TABLE 4
An example number of repetition when two
bits are used and Nmax is configured

| Indicator | Repetition times |
|---|---|
| first value | no repetition |
| (e.g., “00”) | |
| second value | Nmax/4 |
| (e.g. “01”) | |
| third value | Nmax/2 |
| (e.g., “10”) | |
| fourth value | Nmax |
| (e.g., “11”) | |

For a joint indication, the bits may be used to jointly indicate a number of time domain repetitions and a number of frequency domain repetitions (e.g., both may be simultaneously indicated using the same bits). An example of this is shown in Table 5 below.

TABLE 5
An example of joint repetition representation

| Indicator | Repetition times |
|---|---|
| first value | no repetition |
| (e.g., “000”) | |
| second value | 2 freq. + |
| (e.g. “001”) | 1 time |
| third value | 4 freq. + |
| (e.g., “010”) | 1 time |
| fourth value | 8 freq. + |
| (e g , “011”) | 1 time |
| fifth value | 2 freq. + |
| (e.g., “100”) | 2 time |
| sixth value | 4 freq. + |
| (e.g. “101”) | 2 time |
| other value | reserved |
| (e.g., “110”, “111”) | |

In some embodiments, frequency repetitions may have a high priority (which may be related to a time domain burst transmission system). For some embodiments, time repetitions may have a high priority (e.g., a joint indication may be extended to prefer time domain repetitions).

Some embodiments may incorporate a DCI subframe repetition number (e.g., 2 bits), which may carry information related to a number of PDCCH repetitions.

Some embodiments may incorporate a frequency offset parameter (e.g., 2 bits), which may indicate an interlace offset between one instance and an adjacent instance for frequency domain repetition transmission. This field may be configured by an eNB through higher-layer signaling, for example, so that it might not be configured through DCI.

In some embodiments, while information related to WCE may be opportunely set, one or more other fields may be set to a default value. Alternatively, if a new TBS table is introduced, a Modulation and Coding Scheme (MCS) for WCE may be interpreted based on the new TBS table.

For some embodiments, instead of extending DCI for WCE by including additional information, one or more existing fields may be re-interpreted. For example, for DCI format 0B and/or DCI format 4B, an N-bit New Data Indicator (NDI) field and/or an N-bit RV may be re-interpreted to indicate one or more repetition times (e.g., numbers of repetitions in a time domain and/or in a frequency domain).

In various embodiments, these DCI formats may be scrambled via C-RNTI.

In a second type of embodiment for supporting scheduling for UL transmissions for WCE (e.g., PUSCH transmissions), DCI format 6-0A and/or DCI format 6-0B may be used for scheduling of PUSCH and may support WCE for BL/CE UEs in eMTC for CE mode A and CE mode B, respectively. However, these DCI formats might not be supported in MulteFire™. Accordingly, in the context of WCE for MulteFire™, DCI format 6-0A and/or DCI format 6-0B may be reused, and various fields which may be suitable for MulteFire may be added. The added fields may include: a PUSCH or MF-ePUCCH trigger A; a timing offset; a cyclic shift for DMRS and OCC index; a HARQ Acknowledgement (ACK) request; a PUSCH or MF-ePUCCH starting position/ending symbol; a channel access type; a Channel access priority class; and/or a number of scheduled subframes. The selection between the two formats may be triggered depending upon an advantageous or desirable level of repetition.

In various embodiments, these DCI formats may be scrambled via C-RNTI.

In a third type of embodiment for supporting scheduling for UL transmissions for WCE (e.g., PUSCH transmissions), a clean slate solution with a new DCI format may be adopted. The new DCI format may be based upon DCI format 6-0A, and may include merely some of the of DCI format 6-0A based on what may be used for scheduling. In addition, one or more of the fields provided in Table 6 below might be carried.

TABLE 6
Additional fields for a new DCI format

| | DCI |
|---|---|
| | format |
| | 6-2 |
| Field | (bits) |
| Format flag | — |
| Frequency hopping flag | — |
| Modulation and coding scheme (MCS) | 4 or 5 |
| Repetition number (RN) | 2 or 3 |
| DCI subframe repetition number | 2 |
| Resource allocation | 5 or 6 |

In some embodiments, the new DCI format may include one of the fields contained in a DCI format 6-0A, or may include some of the fields contained in a DCI format 6-0A. Furthermore, the new DCI format may include one or more of the additional fields provided in Table 2.

For example, in some embodiments, the new DCI format may include a format flag field, which may be used merely to discern between scheduling of PUSCH and scheduling of PDSCH (if this option is used for both cases). In some embodiments, a frequency hopping flag might not be used, such as where scheduling does not rely on this field. For some embodiments, a DCI subframe repetition number might not be used, such as where a number of repetitions for PDCCH is not dynamically changed.

In various embodiments, these DCI formats may be scrambled via C-RNTI.

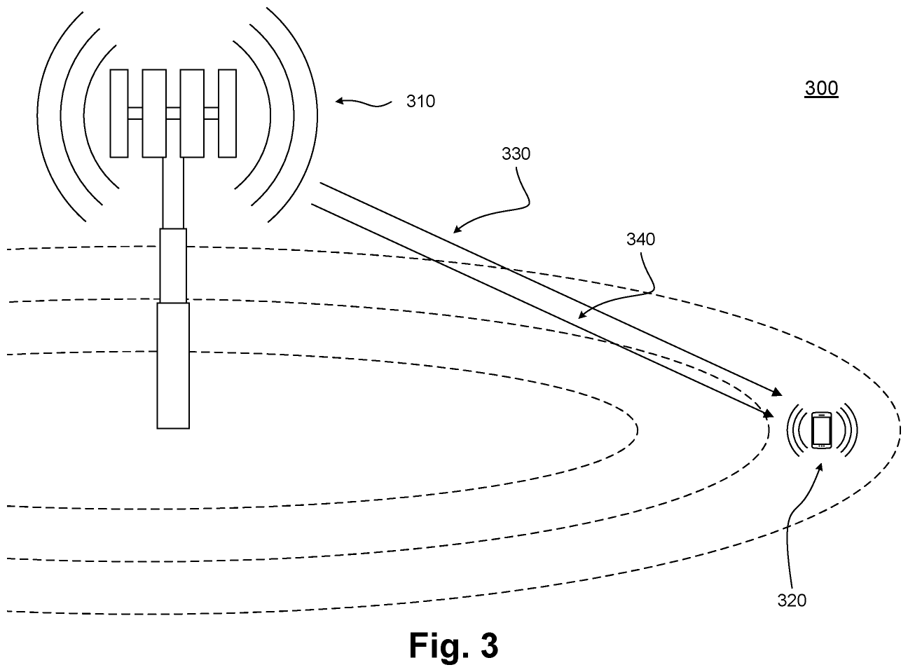

A second variety of embodiments may support scheduling for DL transmissions for WCE (e.g., in MulteFire™ systems), such as PDSCH transmissions, SIB scheduling transmissions, and paging transmissions. FIG. 3 illustrates a scenario of coverage enhancement for DL transmissions, in accordance with some embodiments of the disclosure. A scenario 300 may comprise an eNB 310 and a UE 320. eNB 310 may transmit a DCI transmission 330 to UE 320. DCI transmission 330 may carry one or more indicators for supporting WCE. UE 320 may establish one or more repetition parameters based upon the one or more indicators for supporting WCE (such as repetition parameters for WCE for DL transmissions). UE 320 may then process a subsequent DL transmission 340 from eNB 310 in a WCE mode in accordance with the one or more repetition parameters (for example, by processing DL transmission 340 in a time domain and/or a frequency domain in accordance with the one or more repetition parameters).

In some embodiments, unicast PDSCH scheduling may advantageously be supported by using DCI format 6-1A and/or DCI format 6-1B directly. Alternatively, for some embodiments, DCI format 6-1A and/or DCI format 6-1B may be modified to support larger channel bandwidths for PDSCH scheduling. For example, resource allocation and/or MCS fields may be updated to be similar to fields of DCI format 1A.

In a first type of embodiment for supporting scheduling for DL transmissions for WCE (e.g., SIB scheduling transmissions and/or paging transmissions), various DCI formats may be reused and extended to support WCE (e.g., in MulteFire™ systems). In MulteFire™ systems, both DCI format 1A and DCI format 1C might be used for the scheduling of SIB and/or the scheduling of paging. Table 7 below provides a summary of information that may be carried by these two DCI formats when they are used for scheduling. In Table 7, V may indicate a maximum number of DL VRBs, while N may indicate a VRB increment step.

TABLE 7
DCI format 1A and DCI format 1C

| | DCI | DCI |
|---|---|---|
| | format | format |
| | 1A | 1C |
| Fields | (bits) | (bits) |
| Carrier indicator | 0 or 3 | — |
| Format 0/1A format | 1 | — |
| Localized/Distributed VRB flag | 1 | — |
| Resource Block assignment | Log2(V(V + 1)/2) | Log2(V/N |
| | | (V/N + 1)/2) |
| Modulation and coding scheme (MCS) | 5 | 5 |
| HARQ process number | 4 | — |
| New data indicator | 1 | — |
| Redundancy version | 2 | — |
| TPC command for PUCCH | 2 | — |
| Downlink assignment index | Table 5.3.3.1.2-2 | — |
| | in [1] | |
| SRS request | 0 or 1 | — |
| HARQ-ACK resource offset | 0 or 2 | — |
| HARQ-ACK resource indicator | 2 | — |
| SRS timing offset | 3 | — |
| Gap indication | — | 1 |

In legacy LTE legacy and/or MulteFire™, DCI format 1A and/or DCI format 1C may be used for SIB scheduling by scrambling the DCI formats via System Information Radio Network Temporary Identifier (SI-RNTI) or Paging Radio Network Temporary Identifier (P-RNTI) to carry SI messages and paging. Accordingly, and since these two DCI formats may be supported by MulteFire™, they may extended to support WCE in MulteFire™ systems.

In order to facilitate and/or allow this, and to match information carried by DCI format 6-2 (which may be used in LTE, but might not be supported by MulteFire™) one or more of the following fields may be included along with the existing semantic (e.g., fields) of these DCI formats.

A first field may be a frequency hopping flag (which may be, e.g., 1 bit). The frequency hopping flag may indicate whether frequency hopping is enabled or not.

A second field may be a repetition number (e.g., 2 or 3 bits, or 4 bits). The repetition number may indicate a number of PDSCH repetitions.

A third field may be a DCI subframe repetition number (e.g., 2 bits). The DCI subframe repetition number may indicate a number of PDCCH repetitions.

A fourth field may be a flag for paging/direct indication (e.g., 1 bit). The flag for paging/direct indication may indicate whether a DCI may carry paging or direct indication information.

A fifth field may be a direct indication information (e.g., 8 bits). The direct indication information may provide direct indication of system information updates.

A sixth field may be an MCS (e.g., 3 bits). The MCS may indicate a modulation and coding scheme.

A seventh field may be a resource block assignment (e.g., Log 2(N/6) bits). The resource block assignment may provide information regarding a resource block assignment.

An eighth field may be a repetition indicator (e.g., 1 bit). The repetition indicator may be used to discern between DCI formats.

A ninth field may be a subframe offset (e.g., 1 or 2 bits). The subframe offset may provide an option to define a subframe offset that may help interpreting PDCCH and/or PDSCH when they are not in the same subframe (SF).

In some embodiments, while information related to WCE may be opportunely set, one or more other fields may all be set to default values (e.g., predetermined values). When these DCI formats are scrambled, the HARQ process number and Downlink assignment Index may be reserved (as in legacy LTE).

In some embodiments, repetition information for the time domain, for the frequency domain, or for both may be carried. The information related to the time domain and the frequency domain may be separately indicated, or may be jointly indicated (e.g., in a manner similar to the embodiments disclosed herein pertaining to the first type of embodiment for supporting scheduling for UL transmissions for WCE).

In various embodiments, these DCI formats might be scrambled via P-RNTI (e.g., to perform paging), and/or might be scrambled via SI-RNTI (e.g., to perform SIB scheduling).

In a second type of embodiment for supporting scheduling for DL transmissions for WCE (e.g., SIB scheduling transmissions and/or paging transmissions), DCI format 6-1A, DCI format 6-1B, and/or DCI format 6-2 (whose fields are summarized in Table 1A) may be used to support WCE (e.g., in eMTC). However, in some embodiments, these DCI formats might not be supported in MulteFire™ systems. Furthermore, in some embodiments, these DCI formats might not be used to schedule SIBs.

In various embodiments, these DCI formats might be scrambled via P-RNTI (e.g., to perform paging), and/or might be scrambled via SI-RNTI (e.g., to perform SIB scheduling).

In a third type of embodiment for supporting scheduling for DL transmissions for WCE (e.g., SIB scheduling transmissions and/or paging transmissions), a clean slate solution with a new DCI format may be adopted. The new DCI format may have a structure similar to that of the third type of embodiment for supporting scheduling for UL transmissions for WCE disclosed herein. The new DCI format may carry additional fields, such as one or more of the fields provided in Table 2. In this case, considerations similar to those regarding the fields that may be carried for the third type of embodiment for supporting scheduling for UL transmissions for WCE disclosed herein may be applicable here as well. In some embodiments, the DCI format may include one or more of the fields indicated in Table 2, depending on whether the scheduling may make use of those fields.

In various embodiments, these DCI formats might be scrambled via P-RNTI (e.g., to perform paging), and/or might be scrambled via SI-RNTI (e.g., to perform SIB scheduling).

A third variety of embodiments may support scheduling for various transmissions for WCE (e.g., in MulteFire™ systems). Scenarios for the third variety of embodiments may substantially similar to scenario 100 and/or scenario 200.

In a first type of embodiment for supporting scheduling for various transmissions for WCE, one or more of the DCI formats discussed herein (e.g., DCI format 1A, and/or DCI format 1C) may be extended to include additional information related to WCE and used to allocate resources in this matter. For example, a repetition number field may be added. The repetition number (which may be 2 bits or 3 bits, depending upon whether we adopt CE mode A or CE mode B, or may be 4 bits) may carry information related to a number of PDSCH repetition levels in a time domain and/or in a frequency domain (e.g., corresponding with TBS scaling). The repetition number may be used to indicate a number of time domain repetitions, or a level of TBS scaling, or both. In various embodiments, either separate indications or a joint indication may be provided.

With respect to separate indications, in some embodiments, the first two bits may be used to indicate the number of time domain repetitions, and the last two bits may be used to indicate the TBS scaling level (or vice versa). Alternatively, in some embodiments, the number of time domain repetitions and the TBS scaling level may be carried using a different field length (e.g., 2 bits for the TBS scaling level, and 2 bits for the number of time-domain repetitions).

TABLE 8
Examples of repetition representations when 2 bits are used

| | Example 1 | Example 2 |
|---|---|---|
| Indicator | Repetition times | Repetition times |
| first value | No repetition | No repetition |
| (e.g., “00”) | | |
| second value | 2 times | 2 times |
| (e.g., “01”) | | |
| third value | 4 times | 3 times |
| (e.g., “10”) | | |
| fourth value | 8 times | 4 times |
| (e.g., “11”) | | |

The maximum number of repetition times (which may be indicated in the following by Nmax) may be configured by an eNB (e.g., through higher-layer signaling). In such embodiments, the indicator (e.g., of a number of repetitions) may be re-interpreted to assume a fraction of the Nmax value, as shown in Table 9 below.

TABLE 9
Example of repetition representation when Nmax is configured

| Indicator | Repetition times |
|---|---|
| first value | No repetition |
| (e.g., “00”) | |
| second value | Nmax/4 |
| (e.g., “01”) | |
| third value | Nmax/2 |
| (e.g., “10”) | |
| fourth value | Nmax |
| (e.g., “11”) | |

With respect to joint indications, a field may be utilized to jointly indicate a number of time-domain repetitions and TBS scaling level. An example in which 3 bits are used for joint indication is shown by Table 10A below, and another example in which 2 bits are used for joint indication is shown by Table 10B below.

TABLE 10A
Example of joint repetition representation

| Indicator | Repetition times |
|---|---|
| first value | No repetition |
| (e.g., “000”) | |
| second value | ½ scaling + 1 time |
| (e.g., “001”) | |
| third value | ⅓ scaling + 1 time |
| (e.g., “010”) | |
| fourth value | ¼ scaling + 1 time |
| (e.g., “011”) | |
| fifth value | ½ scaling + 2 time |
| (e.g., “100”) | |
| sixth value | ⅓ scaling + 2 time |
| (e.g., “101”) | |
| other values | reserved |
| (e.g., “110”, “111”) | |

TABLE 10B
Example of joint repetition representation

| Indicator | Repetition times |
|---|---|
| first value | No repetition |
| (e.g., “00”) | |
| second value | ½ scaling + 1 time |
| (e.g., “01”) | |
| third value | ¼ scaling + 1 time |
| (e.g., “10”) | |
| fourth value | ½ scaling + 2 time |
| (e.g., “11”) | |

In some embodiments, the TBS scaling level may have high priority, since it may be a time domain burst transmission system. In some embodiments, the joint indication may also be extended to time domain repetition preferred fashion.

A new DCI format (e.g., having a new size) may created with the newly-added bits to indicate the number of time domain repetitions and/or the TBS scaling. To reduce UE blind search complexity, a UE may be configured to search normal DCI format 1, DCI format 1A, DCI format 1B, DCI format 1C, and/or DCI format 1D when the UE is in conditions of normal coverage. The UE may be configured to search the new DCI format (e.g., DCI format 1E discussed herein) when the UE is in WCE coverage. In some embodiments, the UE may be configured in WCE when an RRC reconfiguration message configures UE with a WCE PDCCH (wce-PDCCH).

In some embodiments, a new DCI format, which may be termed DCI format 1E, may be formed using DCI format 1C as a baseline. For DCI format 1E, a field related to Resource block assignment may be extended to reach the same length of that of other DCI format types (e.g., DCI format 1x). In particular, such a field may be extended by a number of bits

$$⌈ {log}_{2} ⌊ \frac{{N}_{RB}^{{step}^{2}} ( V + 1 )}{V + {N}_{RB}^{step}} ⌋ ⌉ ,$$

where the value of N_{RB}^{step} may be provided by Table 11A. In some embodiments, the extension of such a field may be equivalent to 4 bits total, which may advantageously accommodate various different system bandwidths.

TABLE 11A
Value of the VRB increment step

| System BW | N_{RB}^{step} |
|---|---|
| (N_{RB}^{DL}) | DCI format 1C |
| 6-49 | 2 |
| 50-110 | 4 |

In some embodiments, DCI format 1E may comprise a new field (e.g., 1 bit or 2 bits), which may signal or otherwise indicate a repetition number. DCI format 1E may be formed to include fields as shown by Table 11B below.

TABLE 11B
Example of DCI format 1E

| | DCI |
|---|---|
| | format |
| Fields | 1E (bits) |
| Resource Block assignment | Log2(V (V + 1)/2) |
| Modulation and coding scheme (MCS) | 5 |
| Gap indication | 1 |
| Repetition number | 1 (or 2) bits |

In a second type of embodiment for supporting scheduling for various transmissions for WCE, in order to avoid defining a new DCI format (with consequent increases in terms of complexity for blind decoding), some fields of a DCI format may be reinterpreted, and the information related to the number of repetitions may be embedded within some unused field (e.g., some resource block assignment bits).

For some embodiments, not every DCI format may be utilized by WCE UEs. For example, a DCI format 1A may be advantageous for single TB scheduling, while two TBs might be not available for edge UEs.

In some embodiments, the bit field “HARQ-ACK resource offset” in legacy LTE systems, which may be used to avoid Physical Uplink Control Channel (PUCCH) overlap, due to an associated PDCCH and/or enhanced PDCCH (ePDCCH) index, may be overlapped by the additional information related to the time and frequency repetitions. This field may exist when DCI is transmitted in the ePDCCH. In some embodiments, this field may be re-interpreted as a joint TBS scaling and repetition indication.

For some embodiments, the size of the resource block group (RBG) for WCE users may be increased (e.g., by double, or triple, or even more) in order to reduce a legacy LTE “Resource Block assignment” bit field length. Unutilized bits may then be utilized for either separate TBS scaling and repetition indication, or joint TBS scaling and repetition indication.

In some embodiments, a field related to HARQ process number may be reused and/or reinterpreted in order to carry information related to a number of repetitions for broadcasting.

For some embodiments, when C-RNTI is used, the same DCI may have a bit field that may be re-interpreted to accommodate a newly added number of time domain repetitions and/or TBS scaling information, which a UE may use to determine how to differentiate the DCI. When the UE is in normal coverage, the UE may interpret the bit field as a normal DCI format 1, DCI format 1A, DCI format 1B, DCI format 1C, or DCI format 1D. When UE is in WCE coverage, the UE may interpret the bit field as the WCE bit field as discussed herein. For some embodiments, a UE may be configured in WCE when an RRC reconfiguration message configures the UE with wce-PDCCH.

In some embodiments, DCI format 1A may be reused, and one or more of its fields may be reinterpreted to carry information related to number of repetitions, as described above. In some embodiment, the field reinterpreted in DCI format 1A may be a HARQ process number, which may be reserved when its CRC is scrambled with SI-RNTI and/or P-RNTI. In some embodiments, the reinterpretation may involve another field, or may jointly involve multiple consecutive or non-consecutive fields (e.g., HARQ-ACK resource offset, SRS timing offset, SRS request, and/or HARQ-ACK resource indicator).

In a third type of embodiment for supporting scheduling for various transmissions for WCE, in order to support resource scheduling for PDSCH for WCE in MulteFire™, DCI format 6-1A and/or DCI format 6-1B (whose fields are summarized in Table 1) may be reused and modified to support larger channel BW for PDSCH scheduling. For example, resource allocation and/or MCS fields may be updated to be the same as in DCI format 1A.

In some embodiments, DCI format 6-1A, DCI format 6-1B, and/or DCI format 6-2 may be used to support SIB scheduling and paging, by modifying them accordingly. In this case, the CRC for these formats may be scrambled with SI-RNTI to schedule SIBs or P-RNTI to perform paging.

For some embodiments, a single DCI format may be adopted. For some alternate embodiments, multiple DCI formats may be adopted, and they may all be formed in the same manner (e.g., they may belong to one of the various types of embodiments for supporting scheduling for various transmissions for WCE discussed herein), or they may belong to different options. For example, in some embodiments, DCI format 1E may be adopted, together with DCI format 1A whose fields may be reinterpreted, but its total length may be maintained the same.

For various embodiments, the CRC of the DCI may be scrambled via C-RNTI (e.g., for unicast scheduling of PDSCH), via SI-RNTI (e.g., to schedule SIBs), or via P-RNTI (e.g., to perform paging).

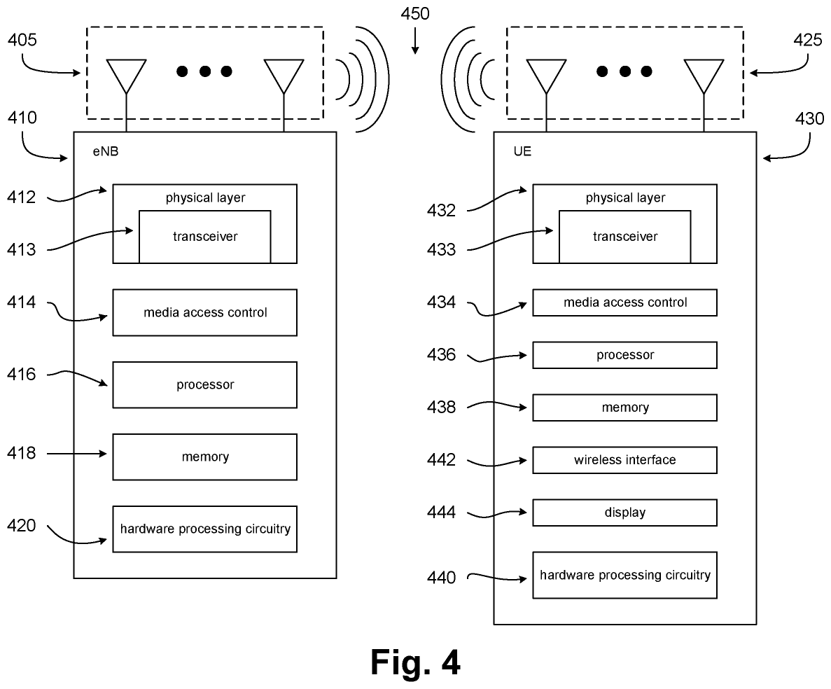

FIG. 4 illustrates an eNB and a UE, in accordance with some embodiments of the disclosure. FIG. 4 includes block diagrams of an eNB 410 and a UE 430 which are operable to co-exist with each other and other elements of an LTE network. High-level, simplified architectures of eNB 410 and UE 430 are described so as not to obscure the embodiments. It should be noted that in some embodiments, eNB 410 may be a stationary non-mobile device.

eNB 410 is coupled to one or more antennas 405, and UE 430 is similarly coupled to one or more antennas 425. However, in some embodiments, eNB 410 may incorporate or comprise antennas 405, and UE 430 in various embodiments may incorporate or comprise antennas 425.

In some embodiments, antennas 405 and/or antennas 425 may comprise one or more directional or omni-directional antennas, including monopole antennas, dipole antennas, loop antennas, patch antennas, microstrip antennas, coplanar wave antennas, or other types of antennas suitable for transmission of RF signals. In some MIMO (multiple-input and multiple output) embodiments, antennas 405 are separated to take advantage of spatial diversity.

eNB 410 and UE 430 are operable to communicate with each other on a network, such as a wireless network. eNB 410 and UE 430 may be in communication with each other over a wireless communication channel 450, which has both a downlink path from eNB 410 to UE 430 and an uplink path from UE 430 to eNB 410.

As illustrated in FIG. 4, in some embodiments, eNB 410 may include a physical layer circuitry 412, a MAC (media access control) circuitry 414, a processor 416, a memory 418, and a hardware processing circuitry 420. A person skilled in the art will appreciate that other components not shown may be used in addition to the components shown to form a complete eNB.

In some embodiments, physical layer circuitry 412 includes a transceiver 413 for providing signals to and from UE 430. Transceiver 413 provides signals to and from UEs or other devices using one or more antennas 405. In some embodiments, MAC circuitry 414 controls access to the wireless medium. Memory 418 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Hardware processing circuitry 420 may comprise logic devices or circuitry to perform various operations. In some embodiments, processor 416 and memory 418 are arranged to perform the operations of hardware processing circuitry 420, such as operations described herein with reference to logic devices and circuitry within eNB 410 and/or hardware processing circuitry 420.

Accordingly, in some embodiments, eNB 410 may be a device comprising an application processor, a memory, one or more antenna ports, and an interface for allowing the application processor to communicate with another device.

As is also illustrated in FIG. 4, in some embodiments, UE 430 may include a physical layer circuitry 432, a MAC circuitry 434, a processor 436, a memory 438, a hardware processing circuitry 440, a wireless interface 442, and a display 444. A person skilled in the art would appreciate that other components not shown may be used in addition to the components shown to form a complete UE.

In some embodiments, physical layer circuitry 432 includes a transceiver 433 for providing signals to and from eNB 410 (as well as other eNBs). Transceiver 433 provides signals to and from eNBs or other devices using one or more antennas 425. In some embodiments, MAC circuitry 434 controls access to the wireless medium. Memory 438 may be, or may include, a storage media/medium such as a magnetic storage media (e.g., magnetic tapes or magnetic disks), an optical storage media (e.g., optical discs), an electronic storage media (e.g., conventional hard disk drives, solid-state disk drives, or flash-memory-based storage media), or any tangible storage media or non-transitory storage media. Wireless interface 442 may be arranged to allow the processor to communicate with another device. Display 444 may provide a visual and/or tactile display for a user to interact with UE 430, such as a touch-screen display. Hardware processing circuitry 440 may comprise logic devices or circuitry to perform various operations. In some embodiments, processor 436 and memory 438 may be arranged to perform the operations of hardware processing circuitry 440, such as operations described herein with reference to logic devices and circuitry within UE 430 and/or hardware processing circuitry 440.

Accordingly, in some embodiments, UE 430 may be a device comprising an application processor, a memory, one or more antennas, a wireless interface for allowing the application processor to communicate with another device, and a touch-screen display.

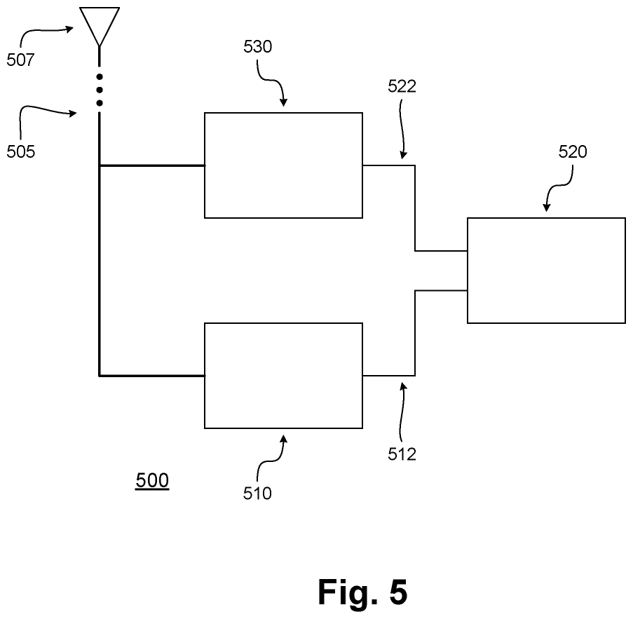

Elements of FIG. 4, and elements of other figures having the same names or reference numbers, can operate or function in the manner described herein with respect to any such figures (although the operation and function of such elements is not limited to such descriptions). For example, FIGS. 5 and 8-9 also depict embodiments of eNBs, hardware processing circuitry of eNBs, UEs, and/or hardware processing circuitry of UEs, and the embodiments described with respect to FIG. 4 and FIGS. 5 and 8-9 can operate or function in the manner described herein with respect to any of the figures.

In addition, although eNB 410 and UE 430 are each described as having several separate functional elements, one or more of the functional elements may be combined and may be implemented by combinations of software-configured elements and/or other hardware elements. In some embodiments of this disclosure, the functional elements can refer to one or more processes operating on one or more processing elements. Examples of software and/or hardware configured elements include Digital Signal Processors (DSPs), one or more microprocessors, DSPs, Field-Programmable Gate Arrays (FPGAs), Application Specific Integrated Circuits (ASICs), Radio-Frequency Integrated Circuits (RFICs), and so on.

FIG. 5 illustrates hardware processing circuitries for a UE for DCI processing for WCE, in accordance with some embodiments of the disclosure. With reference to FIG. 4, a UE may include various hardware processing circuitries discussed herein (such as hardware processing circuitry 500 of FIG. 5), which may in turn comprise logic devices and/or circuitry operable to perform various operations. For example, in FIG. 4, UE 430 (or various elements or components therein, such as hardware processing circuitry 440, or combinations of elements or components therein) may include part of, or all of, these hardware processing circuitries.

In some embodiments, one or more devices or circuitries within these hardware processing circuitries may be implemented by combinations of software-configured elements and/or other hardware elements. For example, processor 436 (and/or one or more other processors which UE 430 may comprise), memory 438, and/or other elements or components of UE 430 (which may include hardware processing circuitry 440) may be arranged to perform the operations of these hardware processing circuitries, such as operations described herein with reference to devices and circuitry within these hardware processing circuitries. In some embodiments, processor 436 (and/or one or more other processors which UE 430 may comprise) may be a baseband processor.

Returning to FIG. 5, an apparatus of UE 430 (or another UE or mobile handset), which may be operable to communicate with one or more eNBs on a wireless network, may comprise hardware processing circuitry 500. In some embodiments, hardware processing circuitry 500 may comprise one or more antenna ports 505 operable to provide various transmissions over a wireless communication channel (such as wireless communication channel 450). Antenna ports 505 may be coupled to one or more antennas 507 (which may be antennas 425). In some embodiments, hardware processing circuitry 500 may incorporate antennas 507, while in other embodiments, hardware processing circuitry 500 may merely be coupled to antennas 507.

Antenna ports 505 and antennas 507 may be operable to provide signals from a UE to a wireless communications channel and/or an eNB, and may be operable to provide signals from an eNB and/or a wireless communications channel to a UE. For example, antenna ports 505 and antennas 507 may be operable to provide transmissions from UE 430 to wireless communication channel 450 (and from there to eNB 410, or to another eNB). Similarly, antennas 507 and antenna ports 505 may be operable to provide transmissions from a wireless communication channel 450 (and beyond that, from eNB 410, or another eNB) to UE 430.

Hardware processing circuitry 500 may comprise various circuitries operable in accordance with the various embodiments discussed herein. With reference to FIG. 5, hardware processing circuitry 500 may comprise a first circuitry 510, a second circuitry 520, and/or a third circuitry 530.

In various embodiments, first circuitry 510 may be operable to process a DCI transmission carrying one or more indicators for supporting WCE. Second circuitry 520 may be operable to establish one or more repetition parameters based upon the one or more indicators for supporting WCE. First circuitry 510 may be operable to provide the one or more indicators for supporting WCE to second circuitry 520 via an interface 512. Third circuitry may be operable to generate a UL transmission in a WCE mode in accordance with the one or more repetition parameters. Second circuitry 520 may be operable to provide the one or more repetition parameters to third circuitry 530 via an interface 522. Hardware processing circuitry may also comprise an interface for receiving the DCI transmission from a receiving circuitry and/or for sending the UL transmission to a transmission circuitry.

In some embodiments, the UL transmission may be a PUSCH transmission, and/or the DCI transmission may carry one or more scheduling indicators for the PUSCH transmission.

For some embodiments, the one or more indicators for supporting WCE may comprise a repetition number parameter indicating a number of PUSCH repetition times in a time domain, and/or a number of PUSCH repetition times in a frequency domain. In some embodiments, an MCE for the WCE mode may be determined based upon an alternative predetermined TBS table. For some embodiments, the DCI transmission may carry one or more of a NDI field and a RV field, and/or the one or more repetition parameters may be based at least in part upon one or more of the NDI field and the RV field.

In some embodiments, the DCI transmission may be one of: a DCI format 6-0A transmission, or a DCI format 6-0B transmission. The DCI transmission may additionally carry: a PUSCH or ePUCCH trigger; a timing offset; a cyclic shift for Demodulation Reference Signal (DM-RS) and OCC index; a HARQ-ACK request; a PUSCH or ePUCCH starting position; a PUSCH or ePUCCH ending symbol; a channel access type; a channel access priority class; and/or a number of scheduled subframes.

For some embodiments, the DCI transmission may carry one or more fields of a DCI format 6-0A transmission. In some embodiments, the DCI transmission may carry: a format flag indicator; a frequency hopping flag indicator; an MCS indicator; an RN indicator; a DCI Subframe Repetition Number indicator; and/or a resource allocation indicator.

In some embodiments, the DCI transmission may be scrambled via a C-RNTI.

In various embodiments, first circuitry 510 may be operable to process a DCI transmission carrying one or more indicators for supporting WCE. Second circuitry 520 may be operable to establish one or more repetition parameters based upon the one or more indicators for supporting WCE. First circuitry 510 may be operable to provide the one or more indicators for supporting WCE to second circuitry 520 via an interface 512. First circuitry 510 may also be operable to process a DL transmission in a WCE mode in accordance with the one or more repetition parameters. Second circuitry 520 may be operable to provide the one or more repetition parameters to third circuitry 530 via interface 512. Hardware processing circuitry may also comprise an interface for receiving the DCI transmission and the DL transmission from a receiving circuitry.

In some embodiments, the DL transmission may be a PDSCH transmission, and/or the DCI transmission may carry one or more scheduling indicators for the PDSCH transmission. For some embodiments, the DL transmission may be a PDSCH transmission, and/or the DCI transmission may be one of: a DCI format 6-1A transmission, or a DCI format 6-1B transmission.

For some embodiments, the DL transmission may be one of: a SIB scheduling transmission, or a paging transmission. The DCI transmission may be one of: a DCI format 6-1A transmission, or a DCI format 6-1B transmission. The DCI transmission may carry one or more of a frequency hopping flag indicator; an RN indicator; a DCI Subframe Repetition Number indicator; a flag for paging or direct indication information indicator; a direct indication information indicator; an MCS indicator; a resource block assignment indicator; a repetition indicator; and a subframe offset indicator. In some embodiments, the one or more indicators for supporting WCE may comprise a repetition number parameter indicating a number of PUSCH repetition times in a time domain, and/or a number of PUSCH repetition times in a frequency domain.

In some embodiments, the DL transmission may be one of: a SIB scheduling transmission, or a paging transmission, and/or the DCI transmission may be one of: a DCI format 6-1A transmission, a DCI format 6-1B transmission, or a DCI format 6-2 transmission.

For some embodiments, the DCI transmission may carry a format flag indicator; a frequency hopping flag indicator; an MCS indicator; an RN indicator; a DCI Subframe Repetition Number indicator; and/or a resource allocation indicator.

In some embodiments, the DCI transmission may be scrambled via one of: a P-RNTI, or a SI-RNTI.

In some embodiments, first circuitry 510, second circuitry 520, and/or third circuitry 530 may be implemented as separate circuitries. In other embodiments, first circuitry 510, second circuitry 520, and/or third circuitry 530 may be combined and implemented together in a circuitry without altering the essence of the embodiments.

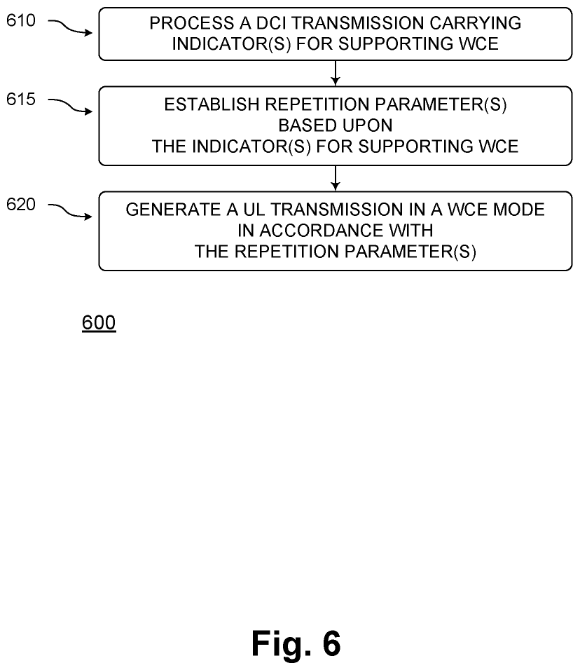

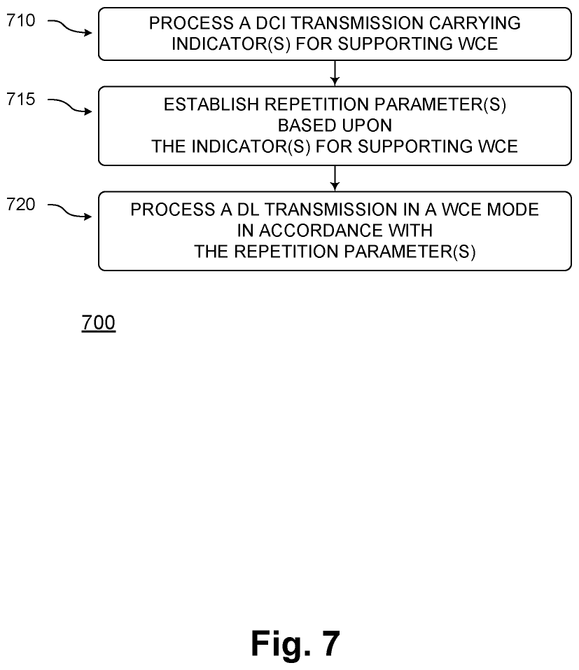

FIG. 6 illustrates methods for a UE for DCI processing for WCE for UL transmissions, in accordance with some embodiments of the disclosure. FIG. 7 illustrates methods for a UE for DCI processing for WCE for DL transmissions, in accordance with some embodiments of the disclosure. With reference to FIG. 4, methods that may relate to UE 430 and hardware processing circuitry 440 are discussed herein. Although the actions in method 600 of FIG. 6 and method 700 of FIG. 7 are shown in a particular order, the order of the actions can be modified. Thus, the illustrated embodiments can be performed in a different order, and some actions may be performed in parallel. Some of the actions and/or operations listed in FIGS. 6 and 7 are optional in accordance with certain embodiments. The numbering of the actions presented is for the sake of clarity and is not intended to prescribe an order of operations in which the various actions must occur. Additionally, operations from the various flows may be utilized in a variety of combinations.

Moreover, in some embodiments, machine readable storage media may have executable instructions that, when executed, cause UE 430 and/or hardware processing circuitry 440 to perform an operation comprising the methods of FIGS. 6 and 7. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

In some embodiments, an apparatus may comprise means for performing various actions and/or operations of the methods of FIGS. 6 and 7.

Returning to FIG. 6, various methods may be in accordance with the various embodiments discussed herein. A method 600 may comprise a processing 610, and establishing 615, and a generating 620. In processing 610, a DCI transmission carrying one or more indicators for supporting WCE may be processed. In establishing 615, one or more repetition parameters may be established based upon the one or more indicators for supporting WCE. In generating 620, a UL transmission in a WCE mode may be generated in accordance with the one or more repetition parameters.

In some embodiments, the UL transmission may be a PUSCH transmission, and/or the DCI transmission may carry one or more scheduling indicators for the PUSCH transmission.

For some embodiments, the one or more indicators for supporting WCE may comprise a repetition number parameter indicating a number of PUSCH repetition times in a time domain, and/or a number of PUSCH repetition times in a frequency domain. In some embodiments, an MCE for the WCE mode may be determined based upon an alternative predetermined TBS table. For some embodiments, the DCI transmission may carry one or more of a NDI field and a RV field, and/or the one or more repetition parameters may be based at least in part upon one or more of the NDI field and the RV field.

In some embodiments, the DCI transmission may be one of: a DCI format 6-0A transmission, or a DCI format 6-0B transmission. The DCI transmission may additionally carry: a PUSCH or ePUCCH trigger; a timing offset; a cyclic shift for DM-RS and OCC index; a HARQ-ACK request; a PUSCH or ePUCCH starting position; a PUSCH or ePUCCH ending symbol; a channel access type; a channel access priority class; and/or a number of scheduled subframes.

For some embodiments, the DCI transmission may carry one or more fields of a DCI format 6-0A transmission. In some embodiments, the DCI transmission may carry: a format flag indicator; a frequency hopping flag indicator; an MCS indicator; an RN indicator; a DCI Subframe Repetition Number indicator; and/or a resource allocation indicator.

In some embodiments, the DCI transmission may be scrambled via a C-RNTI.

Returning to FIG. 7, various methods may be in accordance with the various embodiments discussed herein. A method 700 may comprise a processing 710, an establishing 715, and/or a processing 720. In processing 710, a DCI transmission carrying one or more indicators for supporting WCE may be processed. In establishing 715, one or more repetition parameters may be established based upon the one or more indicators for supporting WCE. In processing 720, a DL transmission may be processed in a WCE mode in accordance with the one or more repetition parameters.

In some embodiments, the DL transmission may be a PDSCH transmission, and/or the DCI transmission may carry one or more scheduling indicators for the PDSCH transmission. For some embodiments, the DL transmission may be a PDSCH transmission, and/or the DCI transmission may be one of: a DCI format 6-1A transmission, or a DCI format 6-1B transmission.

For some embodiments, the DL transmission may be one of: a SIB scheduling transmission, or a paging transmission. The DCI transmission may be one of: a DCI format 6-1A transmission, or a DCI format 6-1B transmission. The DCI transmission may carry one or more of a frequency hopping flag indicator; an RN indicator; a DCI Subframe Repetition Number indicator; a flag for paging or direct indication information indicator; a direct indication information indicator; an MCS indicator; a resource block assignment indicator; a repetition indicator; and a subframe offset indicator. In some embodiments, the one or more indicators for supporting WCE may comprise a repetition number parameter indicating a number of PUSCH repetition times in a time domain, and/or a number of PUSCH repetition times in a frequency domain.

In some embodiments, the DL transmission may be one of: a SIB scheduling transmission, or a paging transmission, and/or the DCI transmission may be one of: a DCI format 6-1A transmission, a DCI format 6-1B transmission, or a DCI format 6-2 transmission.

For some embodiments, the DCI transmission may carry a format flag indicator; a frequency hopping flag indicator; an MCS indicator; an RN indicator; a DCI Subframe Repetition Number indicator; and/or a resource allocation indicator.

In some embodiments, the DCI transmission may be scrambled via one of: a P-RNTI, or a SI-RNTI.

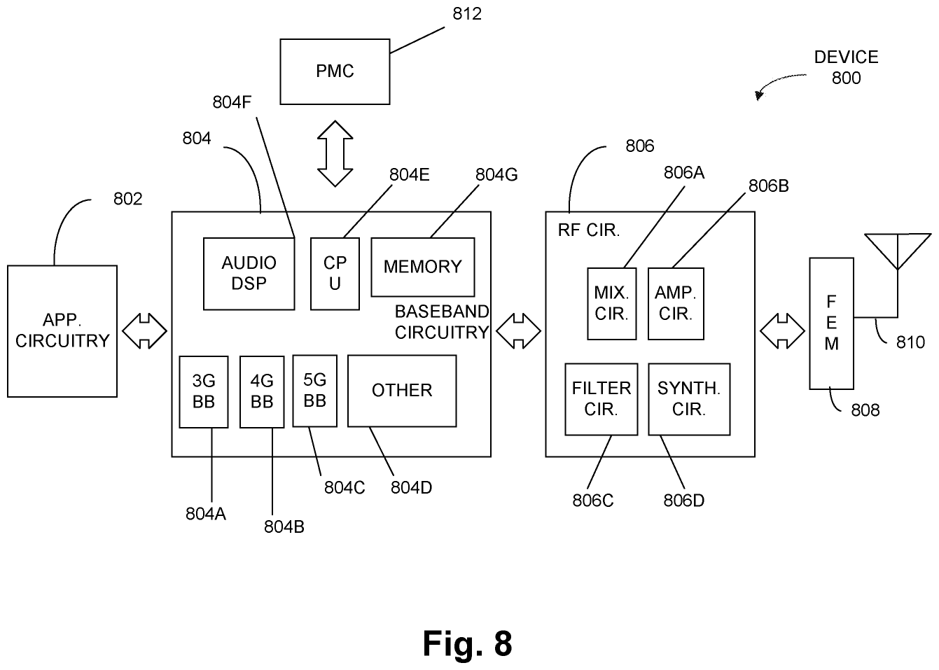

FIG. 8 illustrates example components of a device, in accordance with some embodiments of the disclosure. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, and so on). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), and so on). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, and so on. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, and so on to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806A, amplifier circuitry 806B and filter circuitry 806C. In some embodiments, the transmit signal path of the RF circuitry 806 may include filter circuitry 806C and mixer circuitry 806A. RF circuitry 806 may also include synthesizer circuitry 806D for synthesizing a frequency for use by the mixer circuitry 806A of the receive signal path and the transmit signal path. In some embodiments, the mixer circuitry 806A of the receive signal path may be configured to down-convert RF signals received from the FEM circuitry 808 based on the synthesized frequency provided by synthesizer circuitry 806D. The amplifier circuitry 806B may be configured to amplify the down-converted signals and the filter circuitry 806C may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806A of the receive signal path may comprise passive mixers, although the scope of the embodiments is not limited in this respect.

In some embodiments, the mixer circuitry 806A of the transmit signal path may be configured to up-convert input baseband signals based on the synthesized frequency provided by the synthesizer circuitry 806D to generate RF output signals for the FEM circuitry 808. The baseband signals may be provided by the baseband circuitry 804 and may be filtered by filter circuitry 806C.

In some embodiments, the mixer circuitry 806A of the receive signal path and the mixer circuitry 806A of the transmit signal path may include two or more mixers and may be arranged for quadrature downconversion and upconversion, respectively. In some embodiments, the mixer circuitry 806A of the receive signal path and the mixer circuitry 806A of the transmit signal path may include two or more mixers and may be arranged for image rejection (e.g., Hartley image rejection). In some embodiments, the mixer circuitry 806A of the receive signal path and the mixer circuitry 806A may be arranged for direct downconversion and direct upconversion, respectively. In some embodiments, the mixer circuitry 806A of the receive signal path and the mixer circuitry 806A of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806D may be a fractional-N synthesizer or a fractional N/N+1 synthesizer, although the scope of the embodiments is not limited in this respect as other types of frequency synthesizers may be suitable. For example, synthesizer circuitry 806D may be a delta-sigma synthesizer, a frequency multiplier, or a synthesizer comprising a phase-locked loop with a frequency divider.

The synthesizer circuitry 806D may be configured to synthesize an output frequency for use by the mixer circuitry 806A of the RF circuitry 806 based on a frequency input and a divider control input. In some embodiments, the synthesizer circuitry 806D may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806D of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC Idle state, where it disconnects from the network and does not perform operations such as channel quality feedback, handover, and so on. The device 800 goes into a very low power state and it performs paging where again it periodically wakes up to listen to the network and then powers down again. The device 800 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

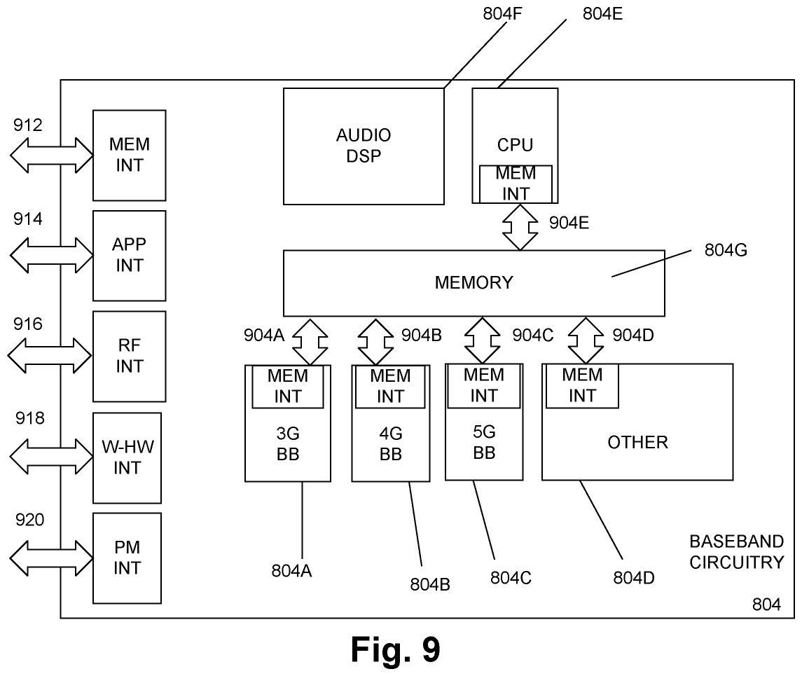

FIG. 9 illustrates example interfaces of baseband circuitry, in accordance with some embodiments of the disclosure. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

It is pointed out that elements of any of the Figures herein having the same reference numbers and/or names as elements of any other Figure herein may, in various embodiments, operate or function in a manner similar those elements of the other Figure (without being limited to operating or functioning in such a manner).

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

Example 1 provides an apparatus of a User Equipment (UE) operable to communicate with an Evolved Node B (eNB) on a wireless network, comprising: one or more processors to: process a Downlink Control Information (DCI) transmission carrying one or more indicators for supporting Wideband Coverage Enhancement (WCE); establish one or more repetition parameters based upon the one or more indicators for supporting WCE; and generate an Uplink (UL) transmission in a WCE mode in accordance with the one or more repetition parameters, and an interface for receiving the DCI transmission from a receiving circuitry and for sending the UL transmission to a transmission circuitry.

In example 2, the apparatus of example 1, wherein the one or more processors are to: wherein the UL transmission is a Physical Uplink Shared Channel (PUSCH) transmission, and wherein the DCI transmission carries one or more scheduling indicators for the PUSCH transmission.

In example 3, the apparatus of any of examples 1 through 2, wherein the one or more processors are to: wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

In example 4, the apparatus of any of examples 1 through 3, wherein the one or more processors are to: wherein a Modulation and Coding Scheme (MCS) for the WCE mode is determined based upon an alternative predetermined Transport Block Size (TBS) table.

In example 5, the apparatus of any of examples 1 through 4, wherein the one or more processors are to: wherein the DCI transmission carries one or more of a New Data Indicator (NDI) field and a Redundancy Version (RV) field; and wherein the one or more repetition parameters is based at least in part upon one or more of the NDI field and the RV field.

In example 6, the apparatus of any of examples 1 through 2, wherein the one or more processors are to: wherein the DCI transmission is one of: a DCI format 6-0A transmission, or a DCI format 6-0B transmission; and wherein the DCI transmission additionally carries one or more of: a Physical Uplink Shared Channel (PUSCH) or enhanced Physical Uplink Control Channel (ePUCCH) trigger; a timing offset; a cyclic shift for Demodulation Reference Signal (DM-RS) and Orthogonal Cover Code (OCC) index; a Hybrid Automatic Repeat Request (HARQ) Acknowledgement (ACK) request; a PUSCH or ePUCCH starting position; a PUSCH or ePUCCH ending symbol; a channel access type; a channel access priority class; or a number of scheduled subframes.

In example 7, the apparatus of any of examples 1 through 2, wherein the one or more processors are to: wherein the DCI transmission carries one or more fields of a DCI format 6-0A transmission.

In example 8, the apparatus of example 7, wherein the one or more processors are to: wherein the DCI transmission carries one or more of: a format flag indicator; a frequency hopping flag indicator; a Modulation and Coding Scheme (MCS) indicator; a Repetition Number (RN) indicator; a DCI Subframe Repetition Number indicator; and a resource allocation indicator.

In example 9, the apparatus of any of examples 1 through 8, wherein the one or more processors are to: wherein the DCI transmission is scrambled via a Cell Radio Network Temporary Identifier (C-RNTI).

Example 10 provides a User Equipment (UE) device comprising an application processor, a memory, one or more antennas, a wireless interface for allowing the application processor to communicate with another device, and a touch-screen display, the UE device including the apparatus of any of examples 1 through 9.

Example 11 provides machine readable storage media having machine executable instructions that, when executed, cause one or more processors of a User Equipment (UE) operable to communicate with an Evolved Node-B (eNB) on a wireless network to perform an operation comprising: process a Downlink Control Information (DCI) transmission carrying one or more indicators for supporting Wideband Coverage Enhancement (WCE); establish one or more repetition parameters based upon the one or more indicators for supporting WCE; and generate an Uplink (UL) transmission in a WCE mode in accordance with the one or more repetition parameters.

In example 12, the machine readable storage media of example 11, the operation comprising: wherein the UL transmission is a Physical Uplink Shared Channel (PUSCH) transmission, and wherein the DCI transmission carries one or more scheduling indicators for the PUSCH transmission.

In example 13, the machine readable storage media of any of examples 11 through 12, the operation comprising: wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

In example 14, the machine readable storage media of any of examples 11 through 13, the operation comprising: wherein a Modulation and Coding Scheme (MCS) for the WCE mode is determined based upon an alternative predetermined Transport Block Size (TBS) table.

In example 15, the machine readable storage media of any of examples 11 through 14, the operation comprising: wherein the DCI transmission carries one or more of a New Data Indicator (NDI) field and a Redundancy Version (RV) field; and wherein the one or more repetition parameters is based at least in part upon one or more of the NDI field and the RV field.

In example 16, the machine readable storage media of any of examples 11 through 12, the operation comprising: wherein the DCI transmission is one of: a DCI format 6-0A transmission, or a DCI format 6-0B transmission; and wherein the DCI transmission additionally carries one or more of: a Physical Uplink Shared Channel (PUSCH) or enhanced Physical Uplink Control Channel (ePUCCH) trigger; a timing offset; a cyclic shift for Demodulation Reference Signal (DM-RS) and Orthogonal Cover Code (OCC) index; a Hybrid Automatic Repeat Request (HARQ) Acknowledgement (ACK) request; a PUSCH or ePUCCH starting position; a PUSCH or ePUCCH ending symbol; a channel access type; a channel access priority class; or a number of scheduled subframes.

In example 17, the machine readable storage media of any of examples 11 through 12, the operation comprising: wherein the DCI transmission carries one or more fields of a DCI format 6-0A transmission.

In example 18, the machine readable storage media of example 17, the operation comprising: wherein the DCI transmission carries one or more of: a format flag indicator; a frequency hopping flag indicator; a Modulation and Coding Scheme (MCS) indicator; a Repetition Number (RN) indicator; a DCI Subframe Repetition Number indicator; and a resource allocation indicator.

In example 19, the machine readable storage media of any of examples 11 through 18, the operation comprising: wherein the DCI transmission is scrambled via a Cell Radio Network Temporary Identifier (C-RNTI).

Example 20 provides an apparatus of a User Equipment (UE) operable to communicate with an Evolved Node B (eNB) on a wireless network, comprising: one or more processors to: process a Downlink Control Information (DCI) transmission carrying one or more indicators for supporting Wideband Coverage Enhancement (WCE); establish one or more repetition parameters based upon the one or more indicators for supporting WCE; and process a Downlink (DL) transmission in a WCE mode in accordance with the one or more repetition parameters, and an interface for receiving the DCI transmission and the DL transmission from a receiving circuitry.

In example 21, the apparatus of example 20, wherein the one or more processors are to: wherein the DL transmission is a Physical Downlink Shared Channel (PDSCH) transmission; and wherein the DCI transmission carries one or more scheduling indicators for the PDSCH transmission.

In example 22, the apparatus of example 21, wherein the one or more processors are to: wherein the DL transmission is a Physical Downlink Shared Channel (PDSCH) transmission; and wherein the DCI transmission is one of: a DCI format 6-1A transmission, or a DCI format 6-1B transmission.

In example 23, the apparatus of example 20, wherein the one or more processors are to: wherein the DL transmission is one of: a System Information Block (SIB) scheduling transmission, or a paging transmission; wherein the DCI transmission is one of: a DCI format 6-1A transmission, or a DCI format 6-1B transmission; and wherein the DCI transmission carries one or more of a frequency hopping flag indicator; a Repetition Number (RN) indicator; a DCI Subframe Repetition Number indicator; a flag for paging or direct indication information indicator; a direct indication information indicator; a Modulation and Coding Scheme (MCS) indicator; a resource block assignment indicator; a repetition indicator; and a subframe offset indicator.

In example 24, the apparatus of example 23, wherein the one or more processors are to: wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

In example 25, the apparatus of example 20, wherein the one or more processors are to: wherein the DL transmission is one of: a System Information Block (SIB) scheduling transmission, or a paging transmission; and wherein the DCI transmission is one of: a DCI format 6-1A transmission, a DCI format 6-1B transmission, or a DCI format 6-2 transmission.

In example 26, the apparatus of example 20, wherein the one or more processors are to: wherein the DCI transmission carries one or more of: a format flag indicator; a frequency hopping flag indicator; a Modulation and Coding Scheme (MCS) indicator; a Repetition Number (RN) indicator; a DCI Subframe Repetition Number indicator; and a resource allocation indicator.

In example 27, the apparatus of any of examples 20 through 26, wherein the one or more processors are to: wherein the DCI transmission is scrambled via one of: a Paging Radio Network Temporary Identifier (P-RNTI), or a System Information Radio Network Temporary Identifier (SI-RNTI).

Example 28 provides a User Equipment (UE) device comprising an application processor, a memory, one or more antennas, a wireless interface for allowing the application processor to communicate with another device, and a touch-screen display, the UE device including the apparatus of any of examples 20 through AltNRF.

Example 29 provides machine readable storage media having machine executable instructions that, when executed, cause one or more processors of a User Equipment (UE) operable to communicate with an Evolved Node-B (eNB) on a wireless network to perform an operation comprising: process a Downlink Control Information (DCI) transmission carrying one or more indicators for supporting Wideband Coverage Enhancement (WCE); establish one or more repetition parameters based upon the one or more indicators for supporting WCE; and process a Downlink (DL) transmission in a WCE mode in accordance with the one or more repetition parameters.

In example 30, the machine readable storage media of example 29, the operation comprising: wherein the DL transmission is a Physical Downlink Shared Channel (PDSCH) transmission; and wherein the DCI transmission carries one or more scheduling indicators for the PDSCH transmission.

In example 31, the machine readable storage media of example 30, the operation comprising: wherein the DL transmission is a Physical Downlink Shared Channel (PDSCH) transmission; and wherein the DCI transmission is one of: a DCI format 6-1A transmission, or a DCI format 6-1B transmission.

In example 32, the machine readable storage media of example 29, the operation comprising: wherein the DL transmission is one of: a System Information Block (SIB) scheduling transmission, or a paging transmission; wherein the DCI transmission is one of: a DCI format 6-1A transmission, or a DCI format 6-1B transmission; and wherein the DCI transmission carries one or more of a frequency hopping flag indicator; a Repetition Number (RN) indicator; a DCI Subframe Repetition Number indicator; a flag for paging or direct indication information indicator; a direct indication information indicator; a Modulation and Coding Scheme (MCS) indicator; a resource block assignment indicator; a repetition indicator; and a subframe offset indicator.

In example 33, the machine readable storage media of example 32, the operation comprising: wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

In example 34, the machine readable storage media of example 29, the operation comprising: wherein the DL transmission is one of: a System Information Block (SIB) scheduling transmission, or a paging transmission; and wherein the DCI transmission is one of: a DCI format 6-1A transmission, a DCI format 6-1B transmission, or a DCI format 6-2 transmission.

In example 35, the machine readable storage media of example 29, the operation comprising: wherein the DCI transmission carries one or more of: a format flag indicator; a frequency hopping flag indicator; a Modulation and Coding Scheme (MCS) indicator; a Repetition Number (RN) indicator; a DCI Subframe Repetition Number indicator; and a resource allocation indicator.

In example 36, the machine readable storage media of any of examples 29 through 35, the operation comprising: wherein the DCI transmission is scrambled via one: of a Paging Radio Network Temporary Identifier (P-RNTI), or a System Information Radio Network Temporary Identifier (SI-RNTI).

In example 37, the apparatus of any of examples 1 through 9, and 20 through 27, wherein the one or more processors comprise a baseband processor.

In example 38, the apparatus of any of examples 1 through 9, and 20 through 27, comprising a memory for storing instructions, the memory being coupled to the one or more processors.

In example 39, the apparatus of any of examples 1 through 9, and 20 through 27, comprising a transceiver circuitry for at least one of: generating transmissions, encoding transmissions, processing transmissions, and decoding transmissions.

In example 40, the apparatus of any of examples 1 through 9, and 20 through 27, comprising a transceiver circuitry for generating transmissions and processing transmissions.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1-24. (canceled)

25. An apparatus of a User Equipment (UE) operable to communicate with an Evolved Node-B (eNB) on a wireless network, comprising:
one or more processors to:
process a Downlink Control Information (DCI) transmission carrying one or more indicators for supporting Wideband Coverage Enhancement (WCE);
establish one or more repetition parameters based upon the one or more indicators for supporting WCE; and
generate an Uplink (UL) transmission in a WCE mode in accordance with the one or more repetition parameters, and
an interface for receiving the DCI transmission from a receiving circuitry and for sending the UL transmission to a transmission circuitry.

26. The apparatus of claim 25, wherein the one or more processors are to:
wherein the UL transmission is a Physical Uplink Shared Channel (PUSCH) transmission, and
wherein the DCI transmission carries one or more scheduling indicators for the PUSCH transmission.

27. The apparatus of claim 25, wherein the one or more processors are to:
wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

28. The apparatus of claim 25, wherein the one or more processors are to:
wherein a Modulation and Coding Scheme (MCS) for the WCE mode is determined based upon an alternative predetermined Transport Block Size (TBS) table.

29. The apparatus of claim 25, wherein the one or more processors are to:
wherein the DCI transmission carries one or more of a New Data Indicator (NDI) field and a Redundancy Version (RV) field; and
wherein the one or more repetition parameters is based at least in part upon one or more of the NDI field and the RV field.

30. The apparatus of claim 25, wherein the one or more processors are to:
wherein the DCI transmission is one of: a DCI format 6-0A transmission, or a DCI format 6-0B transmission; and
wherein the DCI transmission additionally carries one or more of: a Physical Uplink Shared Channel (PUSCH) or enhanced Physical Uplink Control Channel (ePUCCH) trigger; a timing offset; a cyclic shift for Demodulation Reference Signal (DM-RS) and Orthogonal Cover Code (OCC) index; a Hybrid Automatic Repeat Request (HARD) Acknowledgement (ACK) request; a PUSCH or ePUCCH starting position; a PUSCH or ePUCCH ending symbol; a channel access type; a channel access priority class; or a number of scheduled subframes.

31. Machine readable storage media having machine executable instructions that, when executed, cause one or more processors of a User Equipment (UE) operable to communicate with an Evolved Node-B (eNB) on a wireless network to perform an operation comprising:
process a Downlink Control Information (DCI) transmission carrying one or more indicators for supporting Wideband Coverage Enhancement (WCE);
establish one or more repetition parameters based upon the one or more indicators for supporting WCE; and
generate an Uplink (UL) transmission in a WCE mode in accordance with the one or more repetition parameters.

32. The machine readable storage media of claim 31, the operation comprising:
wherein the UL transmission is a Physical Uplink Shared Channel (PUSCH) transmission, and
wherein the DCI transmission carries one or more scheduling indicators for the PUSCH transmission.

33. The machine readable storage media of claim 31, the operation comprising:
wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

34. The machine readable storage media of claim 31, the operation comprising:
wherein a Modulation and Coding Scheme (MCS) for the WCE mode is determined based upon an alternative predetermined Transport Block Size (TBS) table.

35. The machine readable storage media of claim 31, the operation comprising:
wherein the DCI transmission carries one or more of a New Data Indicator (NDI) field and a Redundancy Version (RV) field; and
wherein the one or more repetition parameters is based at least in part upon one or more of the NDI field and the RV field.

36. The machine readable storage media of claim 31, the operation comprising:
wherein the DCI transmission is one of: a DCI format 6-0A transmission, or a DCI format 6-0B transmission; and
wherein the DCI transmission additionally carries one or more of: a Physical Uplink Shared Channel (PUSCH) or enhanced Physical Uplink Control Channel (ePUCCH) trigger; a timing offset; a cyclic shift for Demodulation Reference Signal (DM-RS) and Orthogonal Cover Code (OCC) index; a Hybrid Automatic Repeat Request (HARD) Acknowledgement (ACK) request; a PUSCH or ePUCCH starting position; a PUSCH or ePUCCH ending symbol; a channel access type; a channel access priority class; or a number of scheduled subframes.

37. An apparatus of a User Equipment (UE) operable to communicate with an Evolved Node-B (eNB) on a wireless network, comprising:
one or more processors to:
process a Downlink Control Information (DCI) transmission carrying one or more indicators for supporting Wideband Coverage Enhancement (WCE);
establish one or more repetition parameters based upon the one or more indicators for supporting WCE; and
process a Downlink (DL) transmission in a WCE mode in accordance with the one or more repetition parameters, and
an interface for receiving the DCI transmission and the DL transmission from a receiving circuitry.

38. The apparatus of claim 37, wherein the one or more processors are to:
wherein the DL transmission is a Physical Downlink Shared Channel (PDSCH) transmission; and
wherein the DCI transmission carries one or more scheduling indicators for the PDSCH transmission.

39. The apparatus of claim 38, wherein the one or more processors are to:
wherein the DL transmission is a Physical Downlink Shared Channel (PDSCH) transmission; and
wherein the DCI transmission is one of: a DCI format 6-1A transmission, or a DCI format 6-1B transmission.

40. The apparatus of claim 37, wherein the one or more processors are to:
wherein the DL transmission is one of: a System Information Block (SIB) scheduling transmission, or a paging transmission;
wherein the DCI transmission is one of: a DCI format 6-1A transmission, or a DCI format 6-1B transmission; and
wherein the DCI transmission carries one or more of a frequency hopping flag indicator; a Repetition Number (RN) indicator; a DCI Subframe Repetition Number indicator; a flag for paging or direct indication information indicator; a direct indication information indicator; a Modulation and Coding Scheme (MCS) indicator; a resource block assignment indicator; a repetition indicator; and a subframe offset indicator.

41. The apparatus of claim 40, wherein the one or more processors are to:
wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

42. The apparatus of claim 37, wherein the one or more processors are to:
wherein the DL transmission is one of: a System Information Block (SIB) scheduling transmission, or a paging transmission; and
wherein the DCI transmission is one of: a DCI format 6-1A transmission, a DCI format 6-1B transmission, or a DCI format 6-2 transmission.

43. Machine readable storage media having machine executable instructions that, when executed, cause one or more processors of a User Equipment (UE) operable to communicate with an Evolved Node-B (eNB) on a wireless network to perform an operation comprising:
process a Downlink Control Information (DCI) transmission carrying one or more indicators for supporting Wideband Coverage Enhancement (WCE);
establish one or more repetition parameters based upon the one or more indicators for supporting WCE; and
process a Downlink (DL) transmission in a WCE mode in accordance with the one or more repetition parameters.

44. The machine readable storage media of claim 43, the operation comprising:
wherein the DL transmission is a Physical Downlink Shared Channel (PDSCH) transmission; and
wherein the DCI transmission carries one or more scheduling indicators for the PDSCH transmission.

45. The machine readable storage media of claim 44, the operation comprising:
wherein the DL transmission is a Physical Downlink Shared Channel (PDSCH) transmission; and
wherein the DCI transmission is one of: a DCI format 6-1A transmission, or a DCI format 6-1B transmission.

46. The machine readable storage media of claim 43, the operation comprising:
wherein the DL transmission is one of: a System Information Block (SIB) scheduling transmission, or a paging transmission;
wherein the DCI transmission is one of: a DCI format 6-1A transmission, or a DCI format 6-1B transmission; and
wherein the DCI transmission carries one or more of a frequency hopping flag indicator; a Repetition Number (RN) indicator; a DCI Subframe Repetition Number indicator; a flag for paging or direct indication information indicator; a direct indication information indicator; a Modulation and Coding Scheme (MCS) indicator; a resource block assignment indicator; a repetition indicator; and a subframe offset indicator.

47. The machine readable storage media of claim 46, the operation comprising:
wherein the one or more indicators for supporting WCE comprise a repetition number parameter indicating at least one of: a number of Physical Uplink Shared Channel (PUSCH) repetition times in a time domain, and a number of PUSCH repetition times in a frequency domain.

48. The machine readable storage media of claim 43, the operation comprising:
wherein the DL transmission is one of: a System Information Block (SIB) scheduling transmission, or a paging transmission; and
wherein the DCI transmission is one of: a DCI format 6-1A transmission, a DCI format 6-1B transmission, or a DCI format 6-2 transmission.
